(19) United States
(12) Patent Application Publication
(10) Pub. No.: US 2022/0201633 A1
(43) Pub. Date: Jun. 23, 2022

(54) SUGGESTION FOR TRANSMISSION TIMING ERROR WHEN NR-BASED CELL OR LTE-BASED CELL IS SELECTED AS SYNCHRONIZATION REFERENCE SOURCE FOR V2X SIDELINK COMMUNICATION

(71) Applicant: LG ELECTRONICS INC., Seoul (KE)

(72) Inventors: Yoonoh Yang, Seoul (KR); Sangwook Lee, Seoul (KR); Suhwan Lim, Seoul (KR); Manyoung Jung, Seoul (KR); Jinyup Hwang, Seoul (KR); Jongkeun Park, Seoul (KR)

(21) Appl. No.: 17/601,198

(22) PCT Filed: Mar. 31, 2020
(86) PCT No.: PCT/KR2020/004406

§ 371 Date: Oct. 4, 2021

(30) Foreign Application Priority Data
Apr. 5, 2019 (KR) 10-2019-0040366
Apr. 29, 2019 (KR) 10-2019-0050043
May 2, 2019 (KR) 10-2019-0051490

(51) Int. Cl. H04W 56/00; H04W 4/40

(52) U.S. Cl. CPC H04W 56/0015; H04W 56/0055; H04W 4/40

(57) ABSTRACT

One disclosure of the present specification provides a method for performing vehicle to everything (V2X) communication on a sidelink, the method being performed by a V2X device. The method may comprise a step for selecting one among a plurality of synchronization reference sources which can be used to transmit a V2X signal on a sidelink. The method may comprise: a step for performing time synchronization, in order to transmit the V2X signal on the sidelink, on the basis of a downlink signal from an NR-based cell or an L TE-based cell, on the basis of the NR-based cell or L TE-based cell being selected as a synchronization reference source; and a step for transmitting the V2X signal on the sidelink on the basis of the synchronization.

### TECHNICAL FIELD

The present specification relates to mobile communication.

### BACKGROUND

With the success in the Evolved Universal Terrestrial Radio Access Network (E-UTRAN) for 4th generation mobile communication, i.e., long term evolution (LTE)/LTE-Advanced (LTE-A), interest in the next-generation, i.e., 5th generation (also known as 5G) mobile communication is rising, and researches are in process.

A new radio access technology (New RAT or NR) is being researched for the 5th generation (also known as 5G) mobile communication.

The fifth-generation communication defined by the International Telecommunication Union (ITU) refers to providing a maximum data transmission speed of 20 Gbps and a maximum transmission speed of 100 Mbps per user in anywhere. It is officially called “IMT-2020” and aims to be released around the world in 2020.

Meanwhile, LTE/LTE-A technology and NR technology can also be used for vehicle communication. This is called vehicle-to-everything (V2X). V2X refers to communication technology through all interfaces with the vehicle.

Communication between V2X devices without going through a base station is called V2X communication, and a link used for communication between V2X devices is also called a sidelink.

In order to ensure performance for V2X transmission on the NR-based sidelink, a transmit timing error needs to be technically defined. That is, when performing transmission on the NR-based sidelink for V2X communication, a minimum timing error (Tₑ) must be defined to ensure performance.

However, there is a problem that V2X communication performance cannot be guaranteed because research on this has not been conducted so far.

### BACKGROUND

Accordingly, a disclosure of the present specification has been made in an effort to solve the aforementioned problem.

In order to solve the above problems, one disclosure of the present specification provides a V2X communication method on a sidelink, performed by a vehicle to everything (V2X) device. The method may include selecting one from among a plurality of synchronization reference sources that can be used for transmission of the V2X signal on the sidelink. The method may include based on that the NR-based cell or the LTE-based cell is selected as the synchronization reference source, performing time synchronization for transmission of the V2X signal on the sidelink, based on the downlink signal from the NR-based cell or LTE-based cell; and transmitting a V2X signal on the sidelink, based on the synchronization.

In order to solve the above-mentioned problem, one disclosure of the present specification provides a V2X device that performs V2X (vehicle to everything) communication on a sidelink. The V2X device includes at least one processor; and at least one memory to store instructions and operably electrically connectable to the at least one processor. Based on the instruction being executed by the at least one processor, the operations performed may include: selecting one of a plurality of synchronization reference sources that may be used for transmission of a V2X signal on a sidelink. The operations may include based on that the NR-based cell or the LTE-based cell is selected as the synchronization reference source, performing time synchronization for transmission of the V2X signal on the sidelink, based on the downlink signal from the NR-based cell or LTE-based cell; and transmitting a V2X signal on the sidelink, based on the synchronization.

In order to solve the above problems, one disclosure of the present specification provides a non-volatile computer-readable storage medium in which instructions are stored. The instructions, when executed by one or more processors, may cause the one or more processors to perform operations including: selecting one from among a plurality of synchronization reference sources that can be used for transmission of the V2X signal on the sidelink; based on that the NR-based cell or the LTE-based cell is selected as the synchronization reference source, performing time synchronization for transmission of the V2X signal on the sidelink, based on the downlink signal from the NR-based cell or LTE-based cell; and transmitting a V2X signal on the sidelink, based on the synchronization.

The plurality of synchronization reference sources may include a global navigation satellite system (GNSS), a new radio (NR) based cell, a long term evolution (LTE) based cell, and a synchronization reference user equipment (SyncRefUE).

The transmission timing error (Tₑ) may be predetermined based on the subcarrier spacing (SCS) of the V2X signal on the sidelink, and the subcarrier spacing (SCS) may include 15 kHz, 30 kHz, 60 kHz, and 120 kHz

According to the disclosure of the present disclosure, the problem of the conventional technology described above may be solved.

### BRIEF DESCRIPTION OF THE DRAWINGS

FIG. 1 illustrates a wireless communication system.

FIG. 2 shows a downlink radio frame structure according to FDD of 3GPP long term evolution (LTE).

FIGS. 3A to 3C are diagrams illustrating exemplary architecture for a next-generation mobile communication service.

FIG. 4 shows an example of subframe type in NR.

FIG. 5 shows an example of subframe type in NR.

FIG. 6 is an exemplary diagram illustrating the concept of V2X.

FIG. 7 is an exemplary diagram illustrating an example of using a signal from an artificial satellite as a synchronization signal for V2X communication.

FIG. 8 is an exemplary view showing an example for the disclosure of the present specification.

FIG. 9 shows an device according to an embodiment.

FIG. 10 is a block diagram showing a structure of a terminal according to an embodiment.

FIG. 11 shows a block diagram of a processor in which the disclosure of the present specification is implemented.

FIG. 12 is a detailed block diagram illustrating a transceiver of the first device shown in FIG. 9 or a transceiver of the device shown in FIG. 10.

FIG. 13 illustrates a communication system 1 that can be applied to the present specification.

### DESCRIPTION OF EXEMPLARY EMBODIMENTS

The technical terms used herein are used to merely describe specific embodiments and should not be construed as limiting the present disclosure. Further, the technical terms used herein should be, unless defined otherwise, interpreted as having meanings generally understood by those skilled in the art but not too broadly or too narrowly. Further, the technical terms used herein, which are determined not to exactly represent the spirit of the disclosure, should be replaced by or understood by such technical terms as being able to be exactly understood by those skilled in the art. Further, the general terms used herein should be interpreted in the context as defined in the dictionary, but not in an excessively narrowed manner.

The expression of the singular number in the present specification includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the present specification, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present specification.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present specification will be described in greater detail with reference to the accompanying drawings. In describing the present specification, for ease of understanding, the same reference numerals are used to denote the same components throughout the drawings, and repetitive description on the same components will be omitted. Detailed description on well-known arts which are determined to make the gist of the specification unclear will be omitted. The accompanying drawings are provided to merely make the spirit of the specification readily understood, but not should be intended to be limiting of the specification. It should be understood that the spirit of the specification may be expanded to its modifications, replacements or equivalents in addition to what is shown in the drawings.

As used herein, “A or B” may mean “only A”, “only B”, or “both A and B”. In other words, “A or B” herein may be understood as “A and/or B”. For example, “A, B or C” herein means “only A”, “only B”, “only C”, or any combination of A, B and C (any combination of A, B and C)”.

As used herein, a slash (/) or a comma may mean “and/or”. For example, “A/B” may mean “A and/or B”. Accordingly, “A/B” may mean “only A”, “only B”, or “both A and B”. For example, “A, B, C” may mean “A, B, or C”.

As used herein, “at least one of A and B” may mean “only A”, “only B”, or “both A and B”. In addition, the expression “at least one of A or B” or “at least one of A and/or B” may be understood as “At least one of A and B”.

In addition, in this specification, “at least one of A, B and C” may mean “only A”, “only B”, “only C”, or “any combination of A, B and C”. In addition, “at least one of A, B or C” or “at least one of A, B and/or C” may mean “at least one of A, B and C”.

In addition, the parentheses used herein may mean “for example”. In detail, when “control information (PDCCH (Physical Downlink Control Channel))” is written herein, “PDCCH” may be proposed as an example of “control information”. In other words, “control information” of the present specification is not limited to “PDCCH”, and “PDDCH” may be proposed as an example of “control information”. In addition, even when “control information (i.e. PDCCH)” is written, “PDCCH” may be proposed as an example of “control information”.

The technical features individually described in one drawing in this specification may be implemented separately or at the same time.

In the accompanying drawings, user equipment (UE) is illustrated by way of example, but the illustrated UE may be referred to as a terminal, mobile equipment (ME), and the like. In addition, the UE may be a portable device such as a laptop computer, a mobile phone, a PDA, a smart phone, a multimedia device, or the like, or may be a non-portable device such as a PC or a vehicle-mounted device.

Hereinafter, the UE is used as an example of a device capable of wireless communication (eg, a wireless communication device, a wireless device, or a wireless device). The operation performed by the UE may be performed by any device capable of wireless communication. A device capable of wireless communication may also be referred to as a wireless communication device, a wireless device, or a wireless apparatus.

As used herein, ‘base station’ generally refers to a fixed station that communicates with a wireless device and may be denoted by other terms such as eNodeB (evolved-NodeB), eNB (evolved-NodeB), BTS (base transceiver system), access point or gNB (next-generation NodeB), etc.

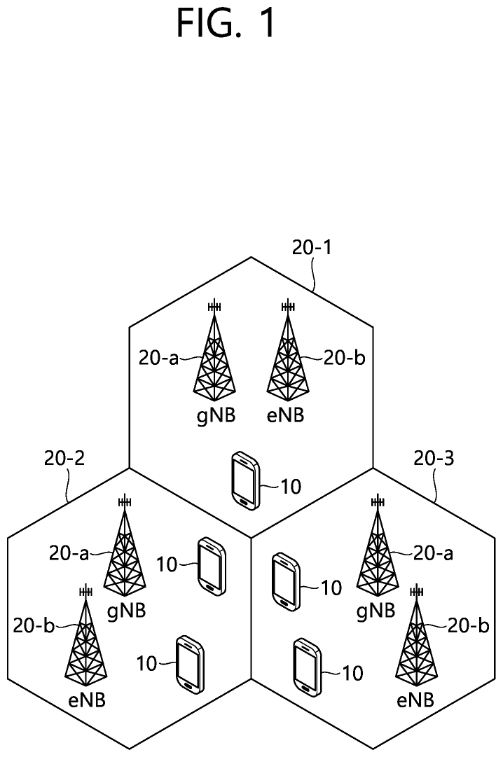

FIG. 1 Illustrates a Wireless Communication System.

As seen with reference to FIG. 1, the wireless communication system includes at least one base station (BS). The BS is classified into a gNodeB (or gNB) 20a and an eNodeB (or eNB) 20b. The gNB 20a supports 5G mobile communication. And, the eNB 20b supports 4G mobile communication, i.e long term evolution (LTE).

Each BS (e.g., 20a and 20b) provides a communication service to specific geographical areas (generally, referred to as cells) 20-1, 20-2, and 20-3. The cell can be further divided into a plurality of areas (sectors).

The UE generally belongs to one cell and the cell to which the UE belong is referred to as a serving cell. A BS that provides the communication service to the serving cell is referred to as a serving BS. Since the wireless communication system is a cellular system, another cell that neighbors to the serving cell is present. Another cell which neighbors to the serving cell is referred to a neighbor cell. A BS that provides the communication service to the neighbor cell is referred to as a neighbor BS. The serving cell and the neighbor cell are relatively decided based on the UE.

Hereinafter, a downlink means communication from the BS 20 to the UE 10 and an uplink means communication from the UE 10 to the BS 200. In the downlink, a transmitter may be a part of the BS 20 and a receiver may be a part of the UE 10. In the uplink, the transmitter may be a part of the UE 10 and the receiver may be a part of the BS 20.

Meanwhile, the wireless communication system may be generally divided into a frequency division duplex (FDD) type and a time division duplex (TDD) type. According to the FDD type, uplink transmission and downlink transmission are achieved while occupying different frequency bands. According to the TDD type, the uplink transmission and the downlink transmission are achieved at different time while occupying the same frequency band. A channel response of the TDD type is substantially reciprocal. This means that a downlink channel response and an uplink channel response are approximately the same as each other in a given frequency area. Accordingly, in the TDD based wireless communication system, the downlink channel response may be acquired from the uplink channel response. In the TDD type, since an entire frequency band is time-divided in the uplink transmission and the downlink transmission, the downlink transmission by the base station and the uplink transmission by the terminal may not be performed simultaneously. In the TDD system in which the uplink transmission and the downlink transmission are divided by the unit of a subframe, the uplink transmission and the downlink transmission are performed in different subframes.

Hereinafter, the LTE system will be described in more detail.

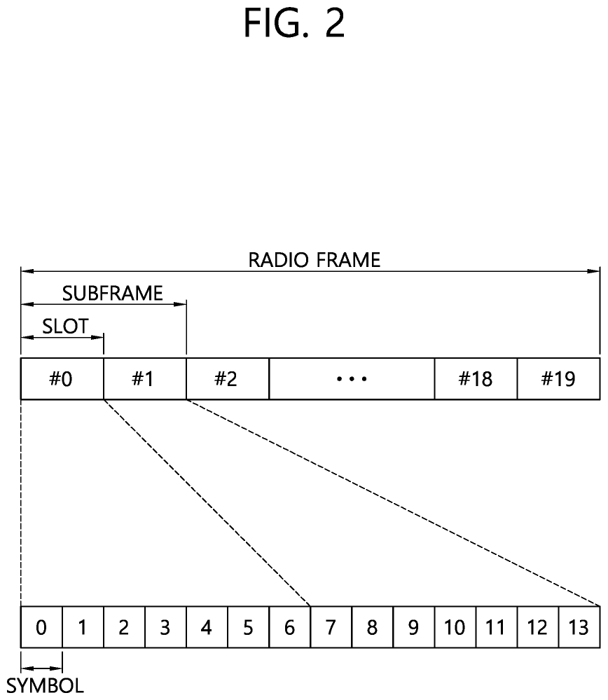

FIG. 2 Shows a Downlink Radio Frame Structure According to FDD of 3GPP Long Term Evolution (LTE).

Referring to FIG. 2, the radio frame includes 10 sub-frames, and one subframe includes 2 slots. Slots in the radio frame are indexed 0 to 19, which are slot numbers. The time taken for one sub-frame to be transmitted is denoted TTI (transmission time interval). TTI may be a scheduling unit for data transmission For example, the length of one sub-frame may be 1 ms, and the length of one slot may be 0.5 ms.

The structure of the radio frame is for exemplary purposes only, and thus the number of sub-frames included in the radio frame or the number of slots included in the sub-frame may change variously.

Meanwhile, one slot may include a plurality of orthogonal frequency division multiplexing (OFDM) symbols. How many OFDM symbols are included in one slot may vary according to a cyclic prefix (CP).

One slot includes N_{RB} resource blocks (RBs) in the frequency domain. For example, in the LTE system, the number of resource blocks (RBs), i.e., NRB, may be one from 6 to 110.

The resource block is a unit of resource allocation and includes a plurality of sub-carriers in the frequency domain. For example, if one slot includes seven OFDM symbols in the time domain and the resource block includes 12 sub-carriers in the frequency domain, one resource block may include 7×12 resource elements (REs).

The physical channels in 3GPP LTE may be classified into data channels such as PDSCH (physical downlink shared channel) and PUSCH (physical uplink shared channel) and control channels such as PDCCH (physical downlink control channel), PCFICH (physical control format indicator channel), PHICH (physical hybrid-ARQ indicator channel) and PUCCH (physical uplink control channel).

The uplink channels include a PUSCH, a PUCCH, an SRS (Sounding Reference Signal), and a PRACH (physical random access channel).

<Next-Generation Mobile Communication Network>

With the success of Evolved Universal Terrestrial Radio Access Network (E-UTRAN) for the fourth-generation mobile communication which is Long Term Evolution (LTE)/LTE-Advanced (LTE-A), the next generation mobile communication, which is the fifth-generation (so called 5G) mobile communication, has been attracting attentions and more and more researches are being conducted.

The fifth-generation communication defined by the International Telecommunication Union (ITU) refers to providing a maximum data transmission speed of 20 Gbps and a maximum transmission speed of 100 Mbps per user in anywhere. It is officially called “IMT-2020” and aims to be released around the world in 2020.

The ITU suggests three usage scenarios, for example, enhanced Mobile BroadBand (eMBB), massive Machine Type Communication (mMTC), and Ultra Reliable and Low Latency Communications (URLLC).

URLLC relates to a usage scenario in which high reliability and low delay time are required. For example, services like autonomous driving, automation, and virtual realities requires high reliability and low delay time (for example, 1 ms or less). A delay time of the current 4G (LTE) is statistically 21-43 ms (best 10%), 33-75 ms (median). Thus, the current 4G (LTE) is not sufficient to support a service requiring a delay time of 1 ms or less. Next, eMBB relates to a usage scenario in which an enhanced mobile broadband is required.

That is, the fifth-generation mobile communication system aims to achieve a capacity higher than the current 4G LTE and is capable of increasing a density of mobile broadband users and support Device-to-Device (D2D), high stability, and Machine Type Communication (MTC). Researches on 5G aims to achieve reduced waiting time and less batter consumption, compared to a 4G mobile communication system, in order to implement the IoT. For the 5G mobile communication, a new radio access technology (New RAT or NR) may be proposed.

An NR frequency band may be defined as two types (FR1 and FR2) of frequency ranges. The frequency ranges may be changed. For example, the two types (FR1 and FR2) of frequency bands are illustrated in Table 1. For the convenience of description, among the frequency bands used in the NR system, FR1 may refer to a “sub-6-GHz range”, FR2 may refer to an “above-6-GHz range” and may be referred to as a millimeter wave (mmWave).

TABLE 1

| Frequency Range | Corresponding frequency | Subcarrier |
|---|---|---|
| designation | range | Spacing |
| FR1 | 450 MHz-6000 MHz | 15, 30, 60 kHz |
| FR2 | 24250 MHz-52600 MHz | 60, 120, 240 kHz |

As described above, the frequency ranges for the NR system may be changed. For example, FR1 may include a range from 410 MHz to 7125 MHz as illustrated in Table 3. That is, FR1 may include a frequency band of 6 GHz or greater (or 5850, 5900, 5925 MHz, or the like). For example, the frequency band of 6 GHz or greater (or 5850, 5900, 5925 MHz or the like) included in FR1 may include an unlicensed band. The unlicensed band may be used for various uses, for example, for vehicular communication (e.g., autonomous driving).

TABLE 2

| Frequency Range | Corresponding frequency | Subcarrier |
|---|---|---|
| designation | range | Spacing |
| FR1 | 410 MHz-7125 MHz | 15, 30, 60 kHz |
| FR2 | 24250 MHz-52600 MHz | 60, 120, 240 kHz |

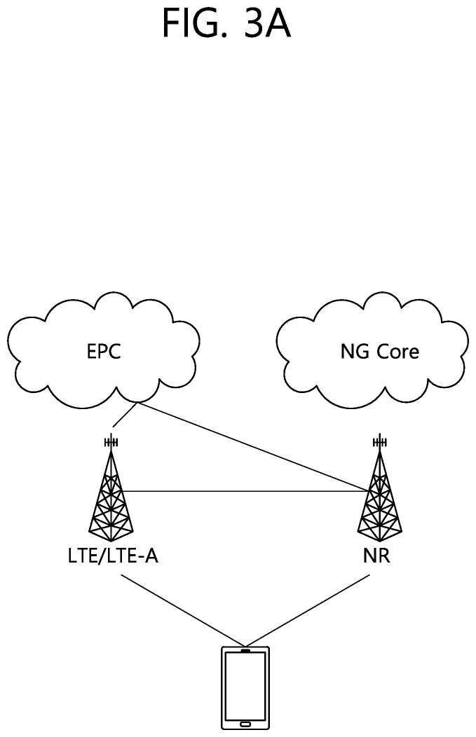

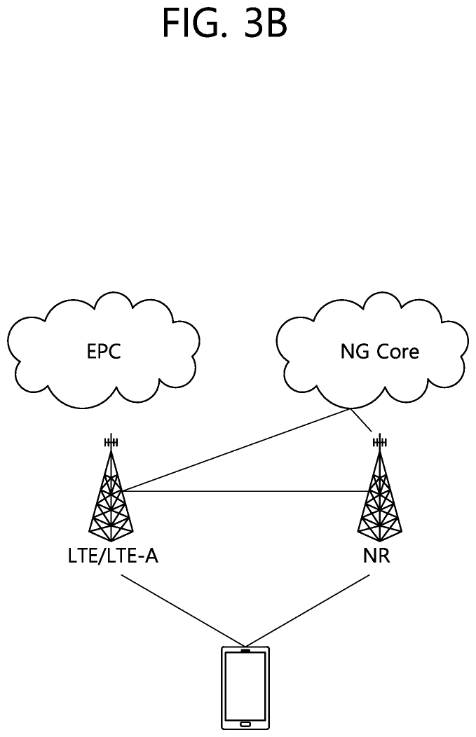

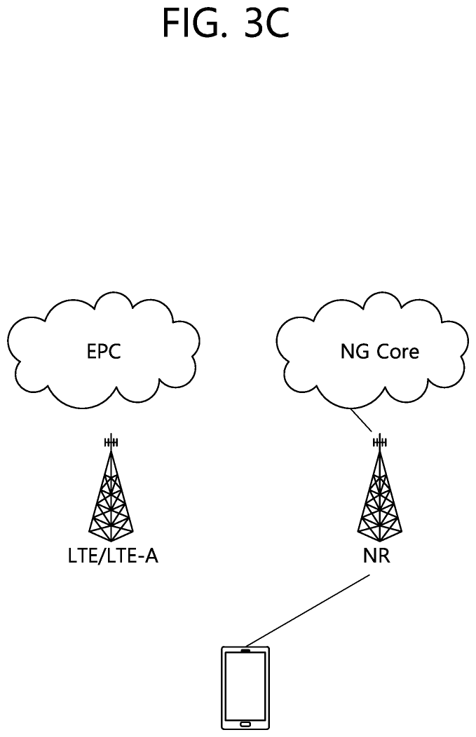

FIGS. 3A to 3C are Diagrams Illustrating Exemplary Architecture for a Next-Generation Mobile Communication Service.

Referring to FIG. 3A, a UE is connected in dual connectivity (DC) with an LTE/LTE-A cell and a NR cell.

The NR cell is connected with a core network for the legacy fourth-generation mobile communication, that is, an Evolved Packet core (EPC).

Referring to FIG. 3B, the LTE/LTE-A cell is connected with a core network for 5th generation mobile communication, that is, a Next Generation (NG) core network, unlike the example in FIG. 3A.

A service based on the architecture shown in FIGS. 3A and 3B is referred to as a non-standalone (NSA) service.

Referring to FIG. 3C, a UE is connected only with an NR cell. A service based on this architecture is referred to as a standalone (SA) service.

Meanwhile, in the above new radio access technology (NR), using a downlink subframe for reception from a base station and using an uplink subframe for transmission to the base station may be considered. This method may be applied to paired spectrums and not-paired spectrums. A pair of spectrum indicates including two subcarrier for downlink and uplink operations. For example, one subcarrier in one pair of spectrum may include a pair of a downlink band and an uplink band.

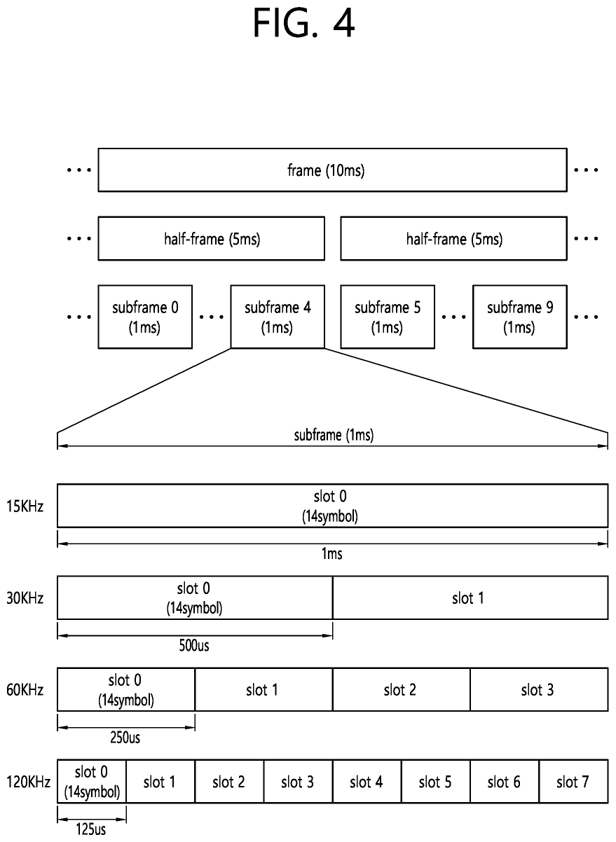

FIG. 4 Shows an Example of Subframe Type in NR.

In NR, uplink and downlink transmission consists of frames. A radio frame has a length of 10 ms and is defined as two 5 ms half-frames (Half-Frame, HF). A half-frame is defined as 5 subframes of 1 ms (Subframe, SF). A subframe is divided into one or more slots, and the number of slots in a subframe depends on subcarrier spacing (SCS). Each slot includes 12 or 14 OFDM(A) symbols according to a cyclic prefix (CP). When normal CP is used, each slot includes 14 symbols. When the extended CP is used, each slot includes 12 symbols. Here, the symbol may include an OFDM symbol (or a CP-OFDM symbol) and an SC-FDMA symbol (or a DFT-s-OFDM symbol).

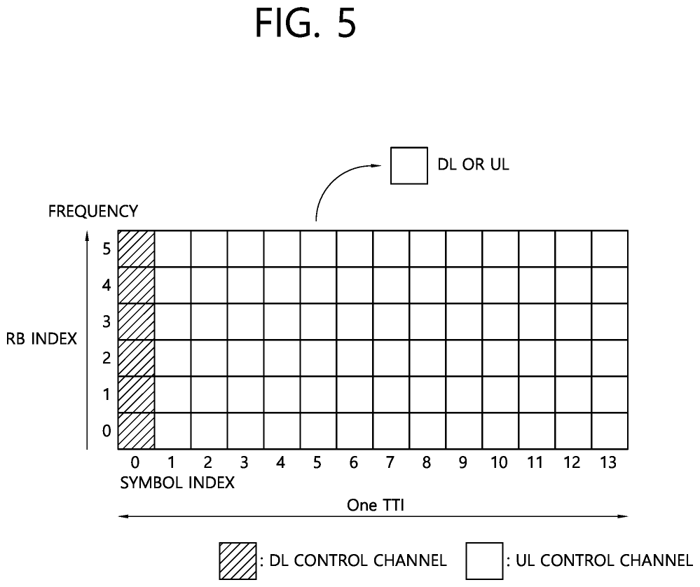

FIG. 5 Shows an Example of Subframe Type in NR.

A transmission time interval (TTI) shown in FIG. 5 may be called a subframe or slot for NR (or new RAT). The subframe (or slot) in FIG. 5 may be used in a TDD system of NR (or new RAT) to minimize data transmission delay. As shown in FIG. 5, a subframe (or slot) includes 14 symbols as does the current subframe. A front symbol of the subframe (or slot) may be used for a downlink control channel, and a rear symbol of the subframe (or slot) may be used for a uplink control channel. Other channels may be used for downlink data transmission or uplink data transmission. According to such structure of a subframe (or slot), downlink transmission and uplink transmission may be performed sequentially in one subframe (or slot). Therefore, a downlink data may be received in the subframe (or slot), and a uplink acknowledge response (ACK/NACK) may be transmitted in the subframe (or slot).

A subframe (or slot) in this structure may be called a self-constrained subframe.

Specifically, the first N symbols in a slot may be used to transmit a DL control channel (hereinafter, DL control region), and the last M symbols in a slot may be used to transmit a UL control channel (hereinafter, UL control region). N and M are each an integer greater than or equal to 0. A resource region (hereinafter, referred to as a data region) between the DL control region and the UL control region may be used for DL data transmission or UL data transmission. For example, the PDCCH may be transmitted in the DL control region and the PDSCH may be transmitted in the DL data region. The PUCCH may be transmitted in the UL control region, and the PUSCH may be transmitted in the UL data region.

If this structure of a subframe (or slot) is used, it may reduce time required to retransmit data regarding which a reception error occurred, and thus, a final data transmission waiting time may be minimized. In such structure of the self-contained subframe (slot), a time gap may be required for transition from a transmission mode to a reception mode or vice versa. To this end, when downlink is transitioned to uplink in the subframe structure, some OFDM symbols may be set as a Guard Period (GP).

<Support of Various Numerologies>

In the next generation system, with development of wireless communication technologies, a plurality of numerologies may be provided to a UE. For example, when SCS is 15 kHz, it supports wide area in traditional cellular bands, and when SCS is 30 kHz/60 kHz, it supports dense-urban, lower latency and a wider carrier bandwidth, and when the SCS is 60 kHz or higher, it supports a bandwidth greater than 24.25 GHz to overcome phase noise.

The numerologies may be defined by a length of cycle prefix (CP) and a subcarrier spacing. One cell may provide a plurality of numerology to a UE. When an index of a numerology is represented by μ, a subcarrier spacing and a corresponding CP length may be expressed as shown in the following table.

TABLE 3

| μ | Δf = 2^{μ} · 15 [kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |

In the case of a normal CP, when an index of a numerology is expressed by μ, the number of OLDM symbols per slot N^{slot}_{symb}, the number of slots per frame N^{frame,μ}ₛₗₒₜ, and the number of slots per subframe N^{subframe,μ}ₛₗₒₜ are expressed as shown in the following table.

TABLE 4

| μ | N^{slot}_{symb} | N^{frame, μ}ₛₗₒₜ | N^{subframe, μ}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In the case of an extended CP, when an index of a numerology is represented by u, the number of OLDM symbols per slot N^{slot}_{symb}, the number of slots per frame N^{frame,μ}ₛₗₒₜ, and the number of slots per subframe N^{subframe,μ}ₛₗₒₜ are expressed as shown in the following table.

TABLE 5

| μ | N^{slot}_{symb} | N^{frame, μ}ₛₗₒₜ | N^{subframe, μ}ₛₗₒₜ |
|---|---|---|---|
| 2 | 12 | 40 | 4 |

<V2X (Vehicle-to-Everything)>

V2X (vehicle-to-everything) refers to communication technology through all interfaces with the vehicle. The implementation form of V2X may be as follows.

In V2X, ‘X’ may mean a person or a pedestrian. In this case, V2X may be displayed as a vehicle-to-person or vehicle-to-pedestrian (V2P). Here, the pedestrian is not necessarily limited to a person moving on foot, and may include a person riding a bicycle, a driver or a passenger of a vehicle (below a certain speed).

Alternatively, ‘X’ may be an infrastructure/network. In this case, V2X may be expressed as V2I (vehicle-to-infrastructure) or V2N (vehicle-to-network), and may mean communication between a vehicle and a roadside unit (ROADSIDE UNIT: RSU) or a vehicle and a network. The roadside device may be a device that informs traffic-related infrastructure, for example, a speed. The roadside device may be implemented in a base station or a fixed terminal.

Alternatively, ‘X’ in V2X may be a vehicle (VEHICLE). In this case, V2X may be expressed as vehicle-to-vehicle (V2V), and may mean communication between vehicles.

A wireless device mounted on a vehicle may be referred to as a V2V device or a V2X device.

Communication between V2X devices without going through a base station is called V2X communication, and a link used for communication between V2X devices is also called a sidelink.

The physical channels used for the sidelink include the following.
PSSCH (Physical Sidelink Shared Channel)
PSCCH (Physical Sidelink Control Channel)
PSDCH (Physical Sidelink Discovery Channel)
PSBCH (Physical Sidelink Broadcast Channel)

In addition, there are the following physical signals used in the side link.
Demodulation Reference signal: DMRS
Sidelink Synchronization signal: SLSS

The SLSS includes a primary sidelink synchronization signal (PSLSS) and a secondary sidelink synchronization signal (Secondary SLSS: SSLSS).

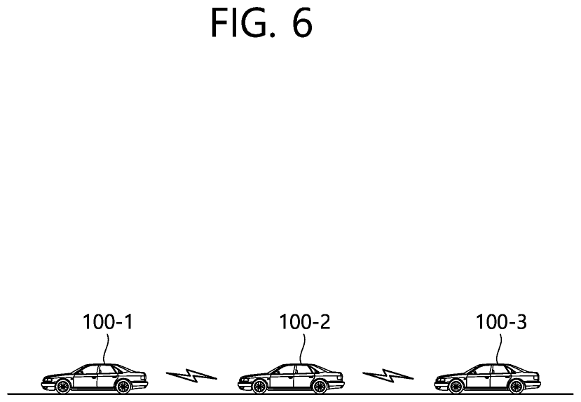

FIG. 6 is an Exemplary Diagram Illustrating the Concept of V2X.

As can be seen with reference to FIG. 6, the wireless devices (ie, V2X devices) 100-1, 100-2, and 100-3 mounted on the vehicle may communicate with each other.

Among the various implementation examples of V2X described above, looking at the implementation example of V2V communication, the vehicle is highly likely to be located in a shaded area in the coverage of the base station or located outside the coverage of the base station.

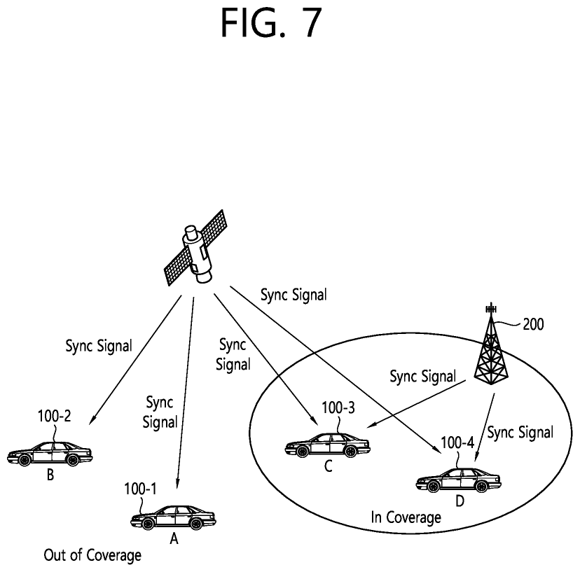

In this way, when the V2X device is located in the shaded range from the coverage of the base station, or is located outside the coverage of the base station, the V2X device may synchronize the time based on the signal from another neighboring V2X device or receives a signal from an artificial satellite. As a reference, time synchronization can be achieved. This will be described with reference to FIG. 7.

FIG. 7 is an Exemplary Diagram Illustrating an Example of Using a Signal from an Artificial Satellite as a Synchronization Signal for V2X Communication.

Referring to FIG. 7, within the coverage of the base station (In Coverage: IC), the V2X device C (100-3) and the V2X device D (100-4) exist, and out of the coverage of the base station (Out of Coverage: OoC) V2X device A (100-1) and a V2X device B (100-2) exist. And, the V2X device A (100-1), the V2X device B (100-2), and the V2X device D (100-4) may receive a signal from an artificial satellite.

Since the V2X device A (100-1) and the V2X device B (100-2) are located outside the coverage of the base station (OC), they cannot receive a synchronization signal from the base station, but they can receive a signal from an artificial satellite. Thus, they may utilize the signal from the artificial satellite as a synchronization signal for V2X communication. The signal from the artificial satellite may be, for example, a Global Positioning System (GPS) signal or a Global Navigation Satellite System (GNSS) signal.

As such, the time synchronization reference source used for the sidelink of V2X communication may include a GNSS, a base station, and a neighboring V2X device. The priority among the plurality of time synchronization reference sources may be as follows.

TABLE 6

| priority | | |
|---|---|---|
| level | GNSS-based synchronization | gNB/eNB based synchronization |
| P0 | GNSS | gNB/eNB |
| P1 | All devices perform direct | All devices perform direct |
| | synchronization based on | synchronization based on |
| | GNSS | gNB/eNB |
| P2 | All devices perform indirect | All devices perform indirect |
| | synchronization based on | synchronization based on |
| | GNSS | gNB/eNB |
| P3 | Any other device or othe UE | GNSS |
| P4 | not available: NA | All devices perform direct |
| | | synchronization based on GNSS |
| P5 | not available: NA | All devices perform indirect |
| | | synchronization based on GNSS |
| P6 | not available: NA | Any other device or othe UE |

Whether GNSS-based synchronization or gNB/eNB-based synchronization is used may be configured in advance. In the operation using one carrier (single-carrier operation), the device (or UE) obtains its transmission timing from the available synchronization criterion, which has the highest priority.

<Problems to be Solved by the Disclosure of this Specification>

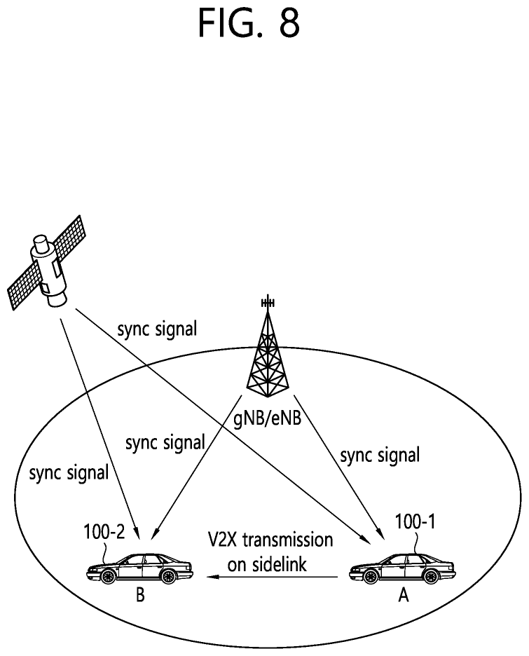

FIG. 8 is an Exemplary View Showing an Example for the Disclosure of the Present Specification.

Referring to FIG. 8, within the coverage of the base station (In Coverage: IC), a V2X device A (100-1) and a V2X device B (100-2) exist.

The V2X device C (100-3) located within the coverage (In Coverage: IC) may include a GNSS, a base station, and a neighboring V2X device as a time synchronization reference source that can be used to perform V2X communication.

The base station may include an eNodeB for LTE and a gNodeB for NR. The base station may include a gNodeB supporting NR and an eNodeB supporting LTE.

When the time synchronization reference source used for the sidelink of the V2X communication is a neighboring V2X device, the V2X device is called SyncRefUE.

Transmission on the sidelink for V2X communication is performed at (N_{TA,SL}+N_{TA offset}×T_{c}) before a time reference frame including a signal transmitted from the time synchronization reference source is received.

Here, N_{TA offset} may be 0, and N_{TA,SL} may be 0.

T_{c} is a basic timing unit, and T_{c} may be T_{c}=1/(Δfₘₐₓ·N_{f}), Δ fₘₐₓ=480·10³ Hz, and N_{f}=4096.

The constant k=Tₛ/T_{c}=64.

Tₛ=1/(Δ f_{ref}·N_{f,ref}), Δ f_{ref}=15·10³, and N_{f,ref}=2048.

On the other hand, in order to guarantee performance for V2X transmission on the NR-based sidelink or LTE-based sidelink, a transmit timing error needs to be technically defined. That is, when performing transmission on the sidelink for V2X communication, a minimum timing error (Tₑ) must be defined to ensure performance.

However, there is a problem that V2X communication performance cannot be guaranteed because research on this has not been conducted so far.

<Disclosures of the Present Specification>

A transmission timing error (NR_V2X_Te) for V2X communication on the NR-based sidelink may be defined with reference to a timing error (NR_Te) for NR-based uplink transmission.

The table below shows the timing error (NR_Te) for NR uplink transmission.

TABLE 7

| Frequency | SCS of SSB signal | SCS of uplink | |
|---|---|---|---|
| Range | (KHz) | signal (KHz) | Te |
| FR1 | 15 | 15 | 12*64*Tc |
| | | 30 | 10*64*Tc |
| | | 60 | 10*64*Tc |
| | 30 | 15 | 8*64*Tc |
| | | 30 | 8*64*Tc |
| | | 60 | 7*64*Tc |
| FR2 | 120 | 60 | 3.5*64*Tc |
| | | 120 | 3.5*64*Tc |
| | 240 | 60 | 3*64*Tc |
| | | 120 | 3*64*Tc |

The timing error (NR_Tₑ) for transmission performed on the NR-based uplink shown in the above table is determined based on the timing error (LTE_Tₑ) for the transmission performed on the LTE-based uplink.

On the other hand, when V2X communication is performed on the LTE-based sidelink, the timing error (LTE_V2X_Tₑ) was determined as follows.
First, when the time synchronization reference source is eNodeB, LTE_V2X_Tₑ=12 Ts was defined.

Specifically, assuming that the LTE-based downlink bandwidth (DL BW)>=3 MHz, the timing error (LTE_V2X_Tₑ) for V2X communication on the LTE-based sidelink is the same as the LTE-based uplink transmission timing error (LTE_Tₑ) of 12 Ts had been defined

LTE_V2X_Tₑ(=LTE_V2X_Tₑ_withoutMargin+margin)=LTE_Tₑ

LTE_V2X_Tₑ_withoutMargin=1/LTE_DL_NRB/2/Ts

LTE_margin=12−LTE_V2X_Tₑ_withoutMargin

TABLE 8

| | | | | | | |
|---|---|---|---|---|---|---|
| LTE based | 1.4 | 3 | 5 | 10 | 15 | 20 |
| downlink | | | | | | |
| bandwidth | | | | | | |
| (DL BW) | | | | | | |
| BWChannel | | | | | | |
| [MHz] | | | | | | |
| LTE transmission | 6 | 15 | 25 | 50 | 75 | 100 |
| bandwidth | | | | | | |
| configuration | | | | | | |
| N_{RB}(=LTE_DL_ | | | | | | |
| NRB) | | | | | | |
| LTE_V2X_Tₑ | No | 12 | 12 | 12 | 12 | 12 |
| (Ts) | define | | | | | |
| LTE_V2X_Tₑ_ | — | 5.689 | 3.413 | 1.707 | 1.138 | 0.853 |
| withoutMargin | | | | | | |
| (Ts) | | | | | | |
| LTE_margin(Ts) | — | 6.311 | 8.587 | 10.293 | 10.862 | 11.147 |

Next, when the time synchronization reference source is GNSS, LTE_V2X_Tₑ=12 Ts was defined.

Specifically, assuming GNSS BW>3 MHz, the time synchronization reference source was defined as the same value as in the case of eNodeB.
Finally, when the time synchronization reference source is SyncRefUE, LTE_V2X_Tₑ=24 Ts was defined.

Specifically, considering LTE V2X PSBCH BW=1.08 MHz, the same 24 Ts as LTE DL BW 1.4 MHz are applied.

Here, 1 Ts=1/(15000*2048) second=64Tc

Similarly, in order to determine the transmission timing error for transmission on the NR-based sidelink for V2X communication, the type of time synchronization reference source is determined whether the V2X device is located within the network coverage (in-network coverage) or outside the network coverage (out-of network coverage) or whether it is partially located within the network coverage (partial network coverage) can be considered as follows.
First, in the case of in-network coverage, the types of available time synchronization reference sources may be gNodeB, eNodeB, and GNSS.

In this case, a case in which a device receives data on the sidelink from the V2X device in the in-network coverage and the device transmits data on the sidelink to the V2X device in the in-network coverage may be considered.
Next, in the case of out-of network coverage, the types of available time synchronization reference sources may be GNSS, SyncRefUE_NR, and SyncRefUE_LTE.

In this case, the case of receiving data on the sidelink from the V2X device in the out-of network coverage, and transmitting data on the sidelink to the V2X device in the out-of network coverage may be considered.
Lastly, in the case of partial network coverage, the types of available time synchronization reference sources may be SyncRefUE_NR, SyncRefUE_LTE, and GNSS.

In this case, the case of receiving data on the sidelink from the V2X device in the in-network coverage and transmitting the data on the sidelink to the V2X device in the out-of network coverage may be considered.

On the other hand, the subcarrier spacing (Subcarrier Spacing: SCS) used in the NR-based sidelink for V2X communication may be 15 kHz, 30 kHz, 60 kHz, 120 kHz.

In consideration of the above, the disclosures of the present specification provide a timing error (Tₑ) for NR-based sidelink transmission for V2X communication based on the type of time synchronization reference source and the type of RAT (radio access technology) used for sidelink. The RAT used for the sidelink may be LTE or NR.

When the RAT used for sidelink is NR, and the time synchronization reference source is eNodeB or gNodeB (that is, when the time synchronization reference source for NR-based sidelink is eNodeB or gNodeB), in order to ensure the V2X communication performance, the first disclosure of the present specification presents the technical minimum requirements for transmit timing error.

The second disclosure of the present specification is when the RAT used for the sidelink is LTE and the time synchronization reference source is gNodeB (that is, when the time synchronization reference source for the LTE-based sidelink is gNodeB), in order to guarantee the performance of the V2X communication, the technical minimum requirements for transmit timing error are presented.

I. First Disclosure

The first disclosure of the present specification presents the technical minimum requirements for the transmission timing error (transmit timing error), in order to ensure the performance of the V2X communication, when the RAT used for the sidelink is NR, and the time synchronization reference source is an eNodeB or gNodeB (that is, when the time synchronization reference source for the NR-based sidelink is an eNodeB or gNodeB).

I-1. Transmission Timing Error, when V2X Communication is Performed on the NR-Based Sidelink Based on the Downlink (DL) Timing of the gNodeB Supporting NR

A part of conventional defined transmission timing error (NR_Tₑ) for the case where transmission is made on the NR-based uplink (UL) can be used for the transmission timing error (NR_V2X_Tₑ) for the case where V2X communication is performed on the NR-based sidelink based on the downlink (DL) timing of the gNodeB supporting NR

NR_V2X_Tₑ=NR_Tₑ (Reuse a part of it under the conditions below)

SCS of DL SSB=15 kHz & SCS for sidelink=15/30/60 kHz

SCS of DL SSB=30 kHz & SCS for sidelink=15/30/60 kHz

SCS of DL SSB=120 kHz & SCS for sidelink=60/120 kHz

SCS of DL SSB=240 kHz & SCS for sidelink=60/120 kHz

TABLE 9

| Frequency | SCS of SSB signal | SCS of sidelink | |
|---|---|---|---|
| range | (KHz) | signal (KHz) | Te |
| FR1 | 15 | 15 | 12*64*Tc |
| | | 30 | 10*64*Tc |
| | | 60 | 10*64*Tc |
| | 30 | 15 | 8*64*Tc |
| | | 30 | 8*64*Tc |
| | | 60 | 7*64*Tc |
| FR2 | 120 | 60 | 3.5*64*Tc |
| | | 120 | 3.5*64*Tc |
| | 240 | 60 | 3*64*Tc |
| | | 120 | 3*64*Tc |

In other conditions below,
when SCS of DL SSB=15 kHz & SCS of sidelink=120 kHz,

NR_V2X_Te_SL_SCS120 kHz=NR_V2X_Te_SL_SCS60 kHz=10*64*Tc
when SCS of DL SSB=30 kHz & SCS of sidelink=15/30/60 kHz,

NR_V2X_Te_SL_SCS120 kHz=NR_V2X_Te_SL_SCS60 kHz=7*64*Tc
when SCS of DL SSB=120 kHz & SCS of sidelink=15/30 kHz,

NR_V2X_Te_SL_SCS15 kHz=NR_V2X_Te_SL_SCS60 kHz+1*64*Tc=4.5*64*Tc

NR_V2X_Te_SL_SCS30 kHz=NR_V2X_Te_SL_SCS15=4.5*64*Tc
when SCS of DL SSB=240 kHz & SCS of sidelink=15/30 kHz,

NR_V2X_Te_SL_SCS15 kHz=NR_V2X_Te_SL_SCS60 kHz+1*64*Tc=4*64*Tc

NR_V2X_Te_SL_SCS30 kHz=NR_V2X_Te_SL_SCS15=4*64*Tc

In summary, this section proposes a timing error (NR_V2X_Tₑ) for V2X communication on the NR-based sidelink as follows.

TABLE 10

| Frequency | SCS of SSB signal | SCS of sidelink | |
|---|---|---|---|
| range | (KHz) | signal (KHz) | NR_V2X_Te |
| FR1 | 15 | 15 | 12*64*Tc |
| | | 30 | 10*64*Tc |
| | | 60(FR1) | 10*64*Tc |
| | | 60(FR2) | [10 ± Δ]*64*Tc |
| | | 120 | [10 ± Δ]**64*Tc |
| | 30 | 15 | 8*64*Tc |
| | | 30 | 8*64*Tc |
| | | 60(FR1) | 7*64*Tc |
| | | 60(FR2) | [7 ± Δ]*64*Tc |
| | | 120 | [7 ± Δ]*64*Tc |
| FR2 | 120 | 15 | [4.5 ± Δ]*64*Tc |
| | | 30 | [4.5 ± Δ]*64*Tc |
| | | 60(FR1) | [4.5 ± Δ]*64*Tc |
| | | 60(FR2) | [3.5 ± Δ]*64*Tc |
| | | 120 | [3.5 ± Δ]*64*Tc |
| | 240 | 15 | [4 ± Δ]*64*Tc |
| | | 30 | [4 ± Δ]*64*Tc |
| | | 60(FR1) | [4 ± Δ]*64*Tc |
| | | 60(FR2) | [3 ± Δ]*64*Tc |
| | | 120 | [3 ± Δ]*64*Tc |

Here, Δ = 2 is proposed for the range error of the standard value.

I-2. Transmission timing error when V2X communication is performed on the NR-based sidelink based on the downlink (DL) timing of the eNodeB supporting LTE The timing error (NR_V2X_Te) for V2X communication on the NR-based sidelink may be obtained as the sum of the transmission timing error (LTE_V2X_Te_withoutMargin) and the margin (A2_margin) defined for V2X communication on the LTE-based sidelink as follows.

NR_V2X_Te=LTE_V2X_Te_withoutMargin+A2_margin, For A2_margin, the margin to be considered first can be inferred from the timing error (NR_Te) for NR-based uplink transmission as shown in the table below. NR_margin=NR_Te−NR_Te_withoutMargin. It can be obtained by using NR_Te_withoutMargin=1/NR_SSB_NRB/2/Ts.

TABLE 11

| | | SS/ | | | | |
|---|---|---|---|---|---|---|
| | SCS | PBCH | | | | |
| | of | (MHz) | SCS of | | | |
| Fre- | SSB | (=NR_ | sidelink | | NR_Te_ | NR_ |
| quency | signal | SSB_ | signal | | withoutMargin | margin |
| range | (KHz) | NRB) | (KHz) | NR_Te | (Ts) | (Ts) |
| FR1 | 15 | 3.6 | 15 | 12*64*Tc | 4.267 | 7.733 |
| | | | 30 | 10*64*Tc | | 5.733 |
| | | | 60 | 10*64*Tc | | 5.733 |
| | 30 | 7.2 | 15 | 8*64*Tc | 2.133 | 5.867 |
| | | | 30 | 8*64*Tc | | 5.867 |
| | | | 60 | 7*64*Tc | | 4.867 |
| FR2 | 120 | 28.8 | 60 | 3.5*64*Tc | 0.533 | 2.967 |
| | | | 120 | 3.5*64*Tc | | 2.967 |
| | 240 | 57.6 | 60 | 3*64*Tc | 0.266 | 2.733 |
| | | | 120 | 3*64*Tc | | 2.733 |

From the NR_margin used for NR_Tₑ, the applicable margin can be proposed as follows according to the combination of the channel bandwidth (CBW) of the LTE-based downlink and the SCS of the NR-based sidelink. Here, the margin for SCS 120 kHz uses the margin of SCS 60 kHz. It is based on the small difference in the size of the channel bandwidth (CBW) between the channel bandwidth (CBW) of the LTE-based downlink and the channel bandwidth (CBW) for the SSB/PBCH in the NR below.

Selected margin=min (LTE_DL_CBW−NR_SSB/PBCH_CBW)

(A) When the channel bandwidth (CBW) of the LTE-based downlink is 3 MHz

A-1) when NR V2X SL SCS=15 kHz, 30 kHz, 60 kHz

NR_margin for {SCS of SS/PBCH is 15 kHz, that is, NR_SSB_NRB=3.6 MHz} is reused

A-2) When NR V2X SL SCS=120 kHz,

Margin_SCS120 kHz=margin_SCS60 kHz

(B) When the channel bandwidth (CBW) of the LTE-based downlink is 5 MHz,

B-1) When NR V2X SL SCS=15 kHz, 30 kHz, 60 kHz,

NR_margin for {SCS of SS/PBCH is 15 kHz, that is, NR_SSB_NRB=3.6 MHz}} is reused

NR_margin for {SCS of SS/PBCH is 30 kHz, that is, NR_SSB_NRB=7.2 MHz}} is reused

B-2) when NR V2X SL SCS=120 kHz,

Margin_SCS120 kHz=margin_SCS60 kHz

(C) When the channel bandwidth (CBW) of the LTE-based downlink is 10 MHz

C-1) when NR V2X SL SCS=15 kHz, 30 kHz, 60 kHz

NR_margin for {SCS of SS/PBCH is 30 kHz, that is, NR_SSB_NRB=7.2 MHz}} is reused

C-2) when NR V2X SL SCS=120 kHz,

Margin_SCS120 kHz=margin_SCS60 kHz

(D) When the channel bandwidth (CBW) of the LTE-based downlink is 15 MHz,

Considering NR_margin of NR DL SSB SCS 30 kHz (CBW (7.2 MHz)) NR DL SSB SCS 120 kHz (CBW (28.8 MHz)), the following is proposed.

D-1) when NR V2X SL SCS=15 kHz, 30 kHz, 60 kHz

Margin=(NR_margin for {SCS of SS/PBCH is 30 kHz, that is, NR_SSB_NRB=7.2 MHz})−1

D-2) When NR V2X SL SCS=120 kHz

Margin_SCS120 kHz=margin_SCS60 kHz

(E) When the channel bandwidth (CBW) of the LTE-based downlink is 20 MHz,

E-1) when NR V2X SL SCS=15 kHz, 30 kHz

Margin_SCS15 kHz=margin_SCS60 kHz+1

Margin_SCS30 kHz=margin_SCS60 kHz+1

E-2) when NR V2X SL SCS=60 kHz, 120 kHz

NR_margin for {SCS of SS/PBCH is 120 kHz, that is, NR_SSB_NRB=28.8 MHz}}

A2_margin that can be finally used may be defined as minimum(NR_margin, LTE_margin).

A2_margin=minimum {NR_margin, LTE_margin}

The timing error (NR_V2X_Tₑ) for V2X communication on the NR-based sidelink can be derived as follows.

NR_V2X_Te=LTE_V2X_Te_withoutMargin+A2_margin

As the final value of NR_V2X_Tₑ,

ceil(LTE_V2X_Te_withoutMargin+A2_margin) or

round(LTE_V2X_Te_withoutMargin+A2_margin) or

floor(LTE_V2X_Te_withoutMargin+A2_margin) is applied.

In this section, through this derivation process, by using ‘ceil(LTE_V2X_Te_withoutMargin+A2_margin)’,

An example of the final value for the timing error (NR_V2X_Tₑ) for V2X communication on the NR-based sidelink is proposed as follows.

TABLE 12

| LTE-based | | | | | | |
|---|---|---|---|---|---|---|
| downlink | | | | | | |
| channel | SCS of | LTE_V2X_ | | | | |
| bandwidth | sidelink | Te_ | | NR_ | A2_ | |
| (CBW) | signals | withoutMargin | LTE_ | margin | margin | NR_V2X_Te |
| [MHz] | (KHz) | (Ts) | margin(Ts) | (Ts) | (Ts) | (Ts(Tc)) |
| 3 | 15 | 5.689 | 6.311 | 7.733 | 6.311 | 12Ts(12*64*Tc) |
| | 30 | | | 5.733 | 5.733 | 12Ts(12*64*Tc) |
| | 60 | | | 5.733 | 5.733 | (12 ± Δ)Ts |
| | | | | | | ((12 ± Δ)*64*Tc) |
| | 120 | | | 5.733 | 5.733 | (12 ± Δ)Ts |
| | | | | | | ((12± Δ)*64*Tc) |
| 5 | 15 | 3.413 | 8.587 | 7.733 | 7.733 | 12Ts(12*64*Tc) |
| | 30 | | | 5.733 | 5.733 | 10Ts(10*64*Tc) |
| | 60 | | | 5.733 | 5.733 | (10 ± Δ)Ts |
| | | | | | | ((10 ± Δ)*64*Tc) |
| | 120 | | | 5.733 | 5.733 | (10 ± Δ)Ts |
| | | | | | | ((10 ± Δ)*64*Tc) |
| 10 | 15 | 1.707 | 10.293 | 5.867 | 5.867 | 8Ts(8*64*Tc) |
| | 30 | | | 5.867 | 5.867 | 8Ts(8*64*Tc) |
| | 60 | | | 4.867 | 4.867 | (7 ± Δ)Ts |
| | | | | | | ((7 ± Δ)*64*Tc) |
| | 120 | | | 4.867 | 4.867 | (7 ± Δ)Ts |
| | | | | | | ((7 ± Δ)*64*Tc) |
| 15 | 15 | 1.138 | 10.862 | 4.867 | 4.867 | 7Ts(7*64*Tc) |
| | 30 | | | 4.867 | 4.867 | 7Ts(7*64*Tc) |
| | 60 | | | 3.867 | 3.867 | (6 ± Δ)Ts |
| | | | | | | ((6 ± Δ)*64*Tc) |
| | 120 | | | 3.867 | 3.867 | (6 ± Δ)Ts |
| | | | | | | ((6 ± Δ)*64*Tc) |
| 20 | 15 | 0.853 | 11.147 | 3.967 | 3.967 | 5Ts(5*64*Tc) |
| | 30 | | | 3.967 | 3.967 | 5Ts(5*64*Tc) |
| | 60 | | | 2.967 | 2.967 | (4 ± Δ)Ts |
| | | | | | | ((4 ± Δ)*64*Tc) |
| | 120 | | | 2.967 | 2.967 | (4 ± Δ)Ts |
| | | | | | | ((4 ± Δ)*64*Tc) |

Here, Δ = 2 is proposed for the range error of the standard value.

If simplification is needed, based on the above results, an example is proposed as follows (based on a large value in each SL SCS).

TABLE 13

| LTE-based downlink | | |
|---|---|---|
| channel bandwidth (CBW) | SCS of sidelink signals | NR_V2X_Te |
| [MHz] | (KHz) | (Ts(Tc)) |
| 3, 5 | 15, 30, 60, 120 | 12Ts(12*64*Tc) |
| 10, 15 | 15, 30, 60, 120 | 8Ts(8*64*Tc) |
| 20 | 15, 30, 60, 120 | 5Ts(5*64*Tc) |

Alternatively, it may be proposed as shown in the table below.

TABLE 14

| | LTE-based | | |
|---|---|---|---|
| | downlink channel | | |
| Frequency | bandwidth (CBW) | SCS of sidelink | NR_V2X_Te |
| Range | [MHz] | signals (KHz) | (Ts(Tc)) |
| FR1 | 3 | 15, 30, 60, 120 | 12Ts(12*64*Tc) |
| | 5 | 15, 30, 60, 120 | 12Ts(12*64*Tc) or |
| | | | 10Ts(10*64*Tc) |
| | 10 | 15, 30, 60, 120 | 8Ts(8*64*Tc) |
| | 15 | 15, 30, 60, 120 | 7Ts(7*64*Tc) |
| | 20 | 15, 30, 60, 120 | 5Ts(5*64*Tc) |

Alternatively, for the FR2 sidelink, it may be proposed as shown in the table below.

TABLE 15

| | LTE-based | SCS of | |
|---|---|---|---|
| | downlink channel | sidelink | |
| Frequency | bandwidth (CBW) | signals | NR_V2X_Te |
| Range | [MHz] | (KHz) | (Ts(Tc)) |
| FR1 | 3, 5 | 60, 120 | (10 ± Δ)Ts((10 ± Δ) * 64 * Tc) |
| | 10, 15 | 60, 120 | (6 ± Δ)Ts((6 ± Δ) * 64 * Tc) |
| | 20 | 60, 120 | (4 ± Δ)Ts((4 ± Δ) * 64 * Tc) |

Here, Δ = 2 is proposed for the range error of the standard value.

Alternatively, it may be proposed as shown in the table below.

TABLE 1

| LTE-based downlink | SCS of | |
|---|---|---|
| channel bandwidth | sidelink signals | NR_V2X_Te |
| (CBW) [MHz] | (KHz) | (Ts(Tc)) |
| 3, 5, 10, 15, 20 | 60, 120 | (10 ± Δ)Ts((10 ± Δ) * 64 * Tc) |

Here, Δ = 4 is proposed for the range error of the standard value.

II. Second Disclosure

The second disclosure of the present specification presents the technical minimum requirements for the transmission timing error (transmit timing error), in order to ensure the performance of the 5G V2X communication, when the RAT used for the sidelink is LTE, and the time synchronization reference source is an gNodeB (that is, when the time synchronization reference source for the LTE-based sidelink is an gNodeB).

II-1. Transmission Timing Error when 5G V2X Communication is Performed on the LTE-Based Sidelink Based on the Downlink (DL) Timing of the gNodeB Supporting NR

When the time synchronization reference source for the LTE-based sidelink is gNodeB, the transmission timing error (5G LTE_V2X_Tₑ) for 5G V2X communication on the LTE-based sidelink may be found based on Tₑ (withoutMargin) and the margin corresponding to the SCS of the LTE-based sidelink.

5G LTE_V2X_Tₑ=NR_UL_Te_withoutMargin+margin,

NR_UL_Te_withoutMargin may be inferred from the NR-based downlink channel bandwidth (CBW).

NR_UL_Tₑ_withoutMargin=1/NR_SSB_NRB/2/Ts

The table below shows the analyzed NR_UL_Tₑ_withoutMargin.

TABLE 17

| | | SS/ | | | | |
|---|---|---|---|---|---|---|
| | SCS | PBCH | SCS | | | |
| | of | (MHz) | of | | | |
| Fre- | SSB | (=NR_ | uplink | | NR_UL_Te_ | NR_ |
| quency | signal | SSB_ | signal | | withoutMargin | margin |
| Range | (KHz) | NRB) | (KHz) | NR_Te | (Ts) | (Ts) |
| FR1 | 15 | 3.6 | 15 | 12*64*Tc | 4.267 | 7.733 |
| | | | 30 | 10*64*Tc | | 5.733 |
| | | | 60 | 10*64*Tc | | 5.733 |
| | 30 | 7.2 | 15 | 8*64*Tc | 2.133 | 5.867 |
| | | | 30 | 8*64*Tc | | 5.867 |
| | | | 60 | 7*64*Tc | | 4.867 |
| FR2 | 120 | 28.8 | 60 | 3.5*64*Tc | 0.533 | 2.967 |
| | | | 120 | 3.5*64*Tc | | 2.967 |
| | 240 | 57.6 | 60 | 3*64*Tc | 0.266 | 2.733 |
| | | | 120 | 3*64*Tc | | 2.733 |

The margin can be inferred from the transmission timing error (LTE_V2X_Tₑ) used when the synchronization reference source for LTE V2X communication on the LTE-based sidelink is the eNodeB.

The table below shows the analyzed margin and transmission timing error.

TABLE 18

| | | | | | | |
|---|---|---|---|---|---|---|
| LTE-based downlink | 1.4 | 3 | 5 | 10 | 15 | 20 |
| channel | | | | | | |
| bandwidth (CBW) | | | | | | |
| [MHz] | | | | | | |
| LTE Transmission | 6 | 15 | 25 | 50 | 75 | 100 |
| Bandwidth | | | | | | |
| Configuration N_{RB} | | | | | | |
| (=LTE_DL_N_{RB}) | | | | | | |
| LTE_V2X_Tₑ(Ts) | No | 12 | 12 | 12 | 12 | 12 |
| | define | | | | | |
| LTE_V2X_Te_ | — | 5.689 | 3.413 | 1.707 | 1.138 | 0.853 |
| withoutMargin(Ts) | | | | | | |
| LTE_margin(Ts) | — | 6.311 | 8.587 | 10.293 | 10.862 | 11.147 |

It is suggested to use the smallest margin value of 6.311 Ts in the table above. margin=6.311 Ts(=LTE_V2X_T_{c}−LTE_V2X_Te_withoutMargin), at LTE DL Channel bandwidth=3 MHz)

Meanwhile, using the NR_UL_Te_withoutMargin and margin 6.311 Ts presented in Table 17, the final value of the transmission timing error (5G LTE_V2X_Tₑ) for 5G V2X communication on the LTE-based sidelink is proposed as follows.

ceil(NR_UL_Te_withoutMargin+margin) or

round(NR_UL_Te_withoutMargin+margin) or

floor(NR_UL_Te_withoutMargin+margin) is applied.

In this section, through this derivation process, by using ‘ceil(NR_UL_Te_withoutMargin+margin)’, the transmission timing error (5G LTE_V2X_Tₑ) for 5G V2X communication on the LTE-based sidelink is proposed as an example of the final value as follows.

TABLE 19

| | | | SCS | | | |
|---|---|---|---|---|---|---|
| | | SS/ | of | | | |
| | SCS | PBCH | LTE | | | |
| NR | of | (MHz) | based | | | |
| Fre- | SSB | (=NR_ | V2X | NR_UL_Te_ | | 5G LTE_ |
| quency | signal | SSB_ | signal | withoutMargin | margin | V2X_Te |
| Range | (KHz) | NRB) | (KHz) | (Ts) | (Ts) | (Ts(Tc)) |
| FR1 | 15 | 3.6 | 15 | 4.267 | 6.311 | (11 ± Δ)Ts |
| | | | | | | ((11 ± Δ)* |
| | | | | | | 64*Tc) |
| | 30 | 7.2 | 15 | 2.133 | 6.311 | (9 ± Δ)Ts |
| | | | | | | ((9 ± Δ)* |
| | | | | | | 64*Tc) |
| FR2 | 120 | 28.8 | 15 | 0.533 | 6.311 | (7 ± Δ)Ts |
| | | | | | | ((7 ± Δ)* |
| | | | | | | 64*Tc) |
| | 240 | 57.6 | 15 | 0.266 | 6.311 | (7 ± Δ)Ts |
| | | | | | | ((7 ± Δ)* |
| | | | | | | 64*Tc) |

Here, Δ = 2 is proposed for the range error of the standard value.

Another example of the transmission timing error (5G LTE_V2X_Tₑ) for 5G V2X communication on the LTE-based sidelink will be described as follows.

The transmission timing error (LTE_V2X_Tₑ) for LTE V2X communication on the LTE-based sidelink is 12 Ts, and compared with 11 Ts, which is the timing error for 5G V2X communication on the LTE-based sidelink (5G LTE_V2X_Tₑ), there is a difference of 1 Ts. Considering that the value difference is not large, it is also possible to use 12 Ts as a reference.

TABLE 20

| | | SS/ | | | | |
|---|---|---|---|---|---|---|
| | SCS | PBCH | SCS | | | |
| NR | of | (MHz) | of LTE | | | |
| Fre- | SSB | (=NR_ | V2X | NR_UL_Te_ | | 5G LTE_ |
| quency | signal | SSB_ | signals | withoutMargin | margin | V2X_Te |
| Range | (KHz) | NRB) | (KHz) | (Ts) | (Ts) | (Ts(Tc)) |
| FR1 | 15 | 3.6 | 15 | 4.267 | 6.311 | (12 ± Δ)Ts |
| | | | | | | ((12 ± Δ)* |
| | | | | | | 64*Tc) |
| | 30 | 7.2 | 15 | 2.133 | 6.311 | (9 ± Δ)Ts |
| | | | | | | ((9 ± Δ)* |
| | | | | | | 64*Tc) |
| FR2 | 120 | 28.8 | 15 | 0.533 | 6.311 | (7 ± Δ)Ts |
| | | | | | | ((7 ± Δ)* |
| | | | | | | 64*Tc) |
| | 240 | 57.6 | 15 | 0.266 | 6.311 | (7 ± Δ)Ts |
| | | | | | | ((7 ± Δ)* |
| | | | | | | 64*Tc) |

Here, Δ = 2 is proposed for the range error of the standard value.

Another example of the transmission timing error (5G LTE_V2X_Tₑ) for 5G V2X communication on the LTE-based sidelink will be described as follows.

Transmission timing error (5G LTE_V2X_Te) for 5G V2X communication on LTE-based sidelink was analyzed as 7 Ts to 11 Ts according to SCS of NR-based downlink, but if the difference in value is not a problem in performance, it is also possible to use the same based on 12 Ts. (12±Δ)Tₛ((12±Δ)*64*T_{c}), where Δ=2 is suggested for the range error of the standard value.

III. Summary of the Disclosures of the Present Specification

The disclosure of the present specification is summarized as follows.

According to the first disclosure or the second disclosure of the present specification, the V2X device may select one from among a plurality of synchronization reference sources that may be used for transmission of the V2X signal on the sidelink.

The plurality of synchronization reference sources may include a global navigation satellite system (GNSS), a new radio (NR)-based cell, a long term evolution (LTE)-based cell, and a synchronization reference user equipment (SyncRefUE).

Based on that the NR-based cell or LTE-based cell is selected as a synchronization reference source, the V2X device may perform time synchronization for transmission of the V2X signal on the sidelink, based on the downlink signal from the NR-based cell or LTE-based cell.

Based on the synchronization, the V2X device may transmit a V2X signal on the sidelink.

For the transmission of the V2X signal on the sidelink, a transmission timing error (Tₑ) is defined,

The transmission timing error (Tₑ) is predetermined based on the subcarrier spacing (SCS) of the V2X signal on the sidelink, and the subcarrier spacing (SCS) may include 15 kHz, 30 kHz, 60 kHz and 120 kHz.

V2X communication performed on the sidelink may be NR-based or LTE-based.

Based on that the NR-based cell is selected as the synchronization reference source, and the V2X communication performed on the sidelink is based on the NR-based, the transmission timing error (Tₑ) may be defined as a timing error (NR_V2X_Tₑ) for V2X communication on the NR-based sidelink in Table 21 or Table 22 below.

TABLE 21

| Frequency | SCS of SSB signal | SCS of sidelink | |
|---|---|---|---|
| Range | (KHz) | signal (KHz) | NR_V2X_Tₑ |
| FR1 | 15 | 15 | 12 * 64 * Tc |
| | | 30 | 10 * 64 * Tc |
| | | 60(FR1) | 10 * 64 * Tc |
| | | 60(FR2) | [10 ± Δ] * 64 * Tc |
| | | 120 | [10 ± Δ] * * 64 * Tc |
| | 30 | 15 | 8 * 64 * Tc |
| | | 30 | 8 * 64 * Tc |
| | | 60(FR1) | 7 * 64 * Tc |
| | | 60(FR2) | [7 ± Δ] * 64 * Tc |
| | | 120 | [7 ± Δ] * 64 * Tc |

Here, Δ = 2 is proposed for the range error of the standard value.

TABLE 22

| | SCS of SSB | SCS of | |
|---|---|---|---|
| Frequency | signal | sidelink | |
| range | (KHz) | signal (KHz) | NR_V2X_Tₑ |
| FR2 | 120 | 15 | [4.5 ± Δ] * 64 * Tc |
| | | 30 | [4.5 ± Δ] * 64 * Tc |
| | | 60(FR1) | [4.5 ± Δ] * 64 * Tc |
| | | 60(FR2) | [3.5 ± Δ] * 64 * Tc |
| | | 120 | [3.5 ± Δ] * 64 * Tc |
| | 240 | 15 | [4 ± Δ] * 64 * Tc |
| | | 30 | [4 ± Δ] * 64 * Tc |
| | | 60(FR1) | [4 ± Δ] * 64 * Tc |
| | | 60(FR2) | [3 ± Δ] * 64 * Tc |
| | | 120 | [3 ± Δ] * 64 * Tc |

Here, Δ = 2 is proposed for the range error of the standard value.

Based on that the LTE-based cell is selected as the synchronization reference source, and the V2X communication performed on the sidelink is based on the NR, the transmission timing error (Tₑ) is may be defined as the timing error (NR_V2X_Tₑ) for V2X communication on the NR-based sidelink in Table 23 or Table 24 below.

TABLE 23

| | channel bandwidth | | |
|---|---|---|---|
| | of LTE based | | |
| Frequency | downlink (CBW) | SCS of sidelink | NR_V2X_Te |
| Range | [MHz] | signal (KHz) | (Ts(Tc)) |
| FR1 | 3 | 15, 30, 60, 120 | 12Ts(12 * 64 * Tc) |
| | 5 | 15, 30, 60, 120 | 12Ts(12 * 64 * Tc) or |
| | | | 10Ts(10 * 64 * Tc) |
| | 10 | 15, 30, 60, 120 | 8Ts(8 * 64 * Tc) |
| | 15 | 15, 30, 60, 120 | 7Ts(7 * 64 * Tc) |
| | 20 | 15, 30, 60, 120 | 5Ts(5 * 64 * Tc) |

For the FR2 sidelink, it can be proposed as shown in the table below.

TABLE 24

| | channel | SCS of | |
|---|---|---|---|
| | bandwidth of LTE | sidelink | |
| Frequency | based downlink | signal | NR_V2X_Te |
| Range | (CBW) [MHz] | (KHz) | (Ts(Tc)) |
| FR1 | 3, 5 | 60, 120 | (10 ± Δ)Ts((10 ± Δ) * 64 * Tc) |
| | 10, 15 | 60, 120 | (6 ± Δ)Ts((6 ± Δ) * 64 * Tc) |
| | 20 | 60, 120 | (4 ± Δ)Ts((4 ± Δ) * 64 * Tc) |

Here, Δ = 2 is proposed for the range error of the standard value.

Based on that the NR-based cell is selected as the synchronization reference source, and the V2X communication performed on the sidelink is based on LTE, the transmission timing error (Tₑ) is may be defined as the timing error for V2X communication (LTE_V2X_Tₑ) on the LTE-based sidelink in Table 25 below.

TABLE 25

| | SCS of SSB | SCS of LTE | |
|---|---|---|---|
| NR Frequency | signal | based V2X | 5G LTE_V2X_Te |
| Range | (KHz) | signal (KHz) | (Ts(Tc)) |
| FR1 | 15 | 15 | (12 ± Δ)Ts((12 ± Δ) * 64 * Tc) |
| | 30 | 15 | (9 ± Δ)Ts((9 ± Δ) * 64 * Tc) |
| FR2 | 120 | 15 | (7 ± Δ)Ts((7 ± Δ) * 64 * Tc) |
| | 240 | 15 | (7 ± Δ)Ts((7 ± Δ) * 64 * Tc) |

Here, Δ = 2 is proposed for the range error of the standard value.

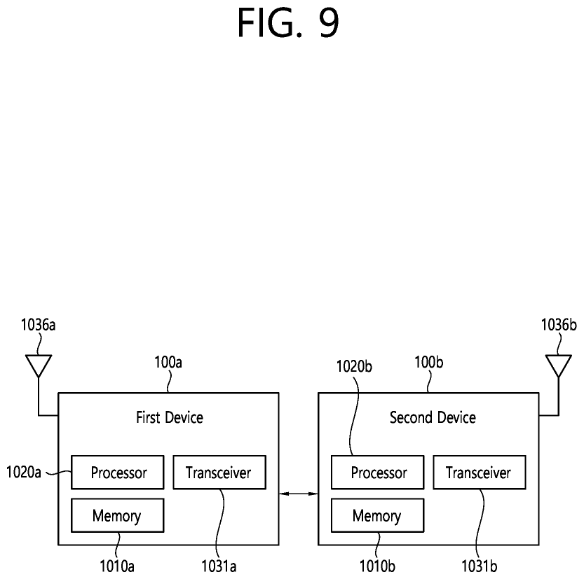

The above-described operation may be implemented by the device of FIGS. 9 to 12 to be described below.

IV. General Device to which the Disclosure of this Specification can be Applied

The disclosures of the present specification described so far may be implemented through various means. For example, the disclosures of the present specification may be implemented by hardware, firmware, software, or a combination thereof. Specifically, it will be described with reference to the drawings.

FIG. 9 Shows an Device According to an Embodiment.

Referring to FIG. 9, a wireless communication system may include a first device 100a and a second device 100b.

The first device 100a is a base station, a network node, a transmitting terminal, a receiving terminal, a wireless device, a wireless communication device, a vehicle, a vehicle equipped with an autonomous driving function, a connected car, a drone (Unmanned Aerial Vehicle, UAV), Artificial Intelligence (AI) Module, Robot, AR (Augmented Reality) Device, VR (Virtual Reality) Device, MR (Mixed Reality) Device, Hologram Device, Public Safety Device, MTC Device, IoT Device, Medical Device, Fintech device (or financial device), a security device, a climate/environment device, a device related to 5G services, or other devices related to the 4th industrial revolution field.

The second device 100b is a base station, a network node, a transmitting terminal, a receiving terminal, a wireless device, a wireless communication device, a vehicle, a vehicle equipped with an autonomous driving function, a connected car, a drone (Unmanned Aerial Vehicle, UAV), Artificial Intelligence (AI) Module, Robot, AR (Augmented Reality) Device, VR (Virtual Reality) Device, MR (Mixed Reality) Device, Hologram Device, Public Safety Device, MTC Device, IoT Device, Medical Device, Fintech device (or financial device), a security device, a climate/environment device, a device related to 5G services, or other devices related to the 4th industrial revolution field.

The first device 100a may include at least one processor, such as a processor 1020a, at least one memory, such as a memory 1010a, and at least one or more transceivers, such as a transceiver 1031a. The processor 1020a may perform the functions, procedures, and/or methods described above. The processor 1020a may perform one or more protocols. For example, the processor 1020a may perform one or more layers of an air interface protocol. The memory 1010a is connected to the processor 1020a and may store various types of information and/or instructions. The transceiver 1031a may be connected to the processor 1020a and may be controlled to transmit/receive a wireless signal.

The second device 100b may include at least one processor, such as a processor 1020a, at least one memory, such as a memory 1010b, and at least one or more transceivers, such as a transceiver 1031b. The processor 1020b may perform the functions, procedures, and/or methods described above. The processor 1020b may perform one or more protocols. For example, the processor 1020b may perform one or more layers of an air interface protocol. The memory 1010b is connected to the processor 1020b and may store various types of information and/or instructions. The transceiver 1031b may be connected to the processor 1020b and may be controlled to transmit/receive a wireless signal.

The memory 1010a and/or the memory 1010b may be respectively connected inside or outside the processor 1020a and/or the processor 1020b, and may be connected to other processors through various technologies such as wired or wireless connection.

The first device 100a and/or the second device 100b may have one or more antennas. For example, antenna 1036a and/or antenna 1036b may be configured to transmit and receive wireless signals.

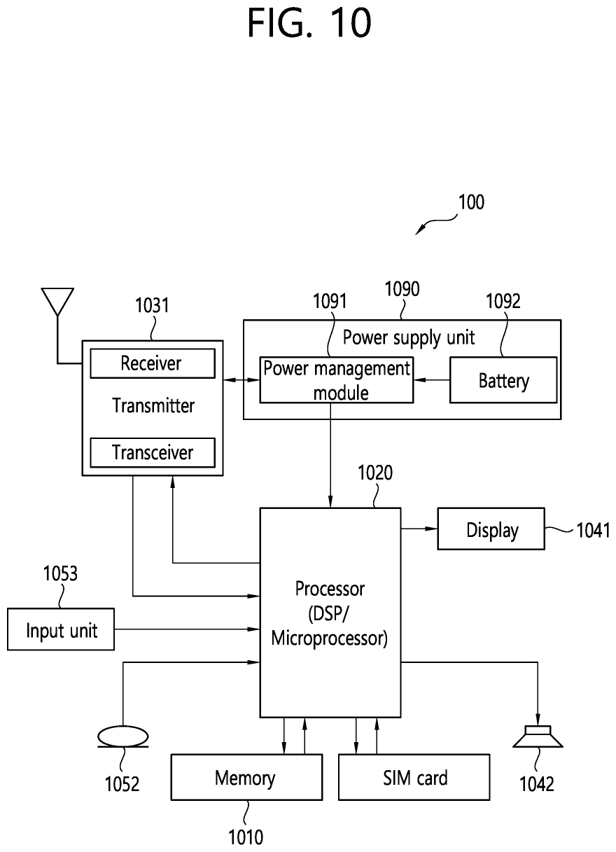

FIG. 10 is a Block Diagram Showing a Structure of a Terminal According to an Embodiment.

In particular, FIG. 10 shows an example of the terminal in FIG. 9 greater detail.

A terminal includes a memory 1010, a processor 1020, a transceiver 1031, a power management module 1091, a battery 1092, a display 1041, an input unit 1053, a speaker 1042, a microphone 1052, a subscriber identification module (SIM) card, and one or more antennas.

The processor 1020 may be configured to implement the proposed functions, procedures, and/or methods described in the present specification. Layers of a radio interface protocol may be implemented in the processor 1020. The processor 1020 may include application-specific integrated circuits (ASICs), other chipsets, logic circuits, and/or data processing units. The processor 1020 may be an application processor (AP). The processor 1020 may include at least one of a digital signal processor (DSP), a central processing unit (CPU), a graphics processing unit (GPS), and a modulator and demodulator (modem). An example of the processor 1020 may include an SNAPDRAGON™ series processor manufactured by Qualcomm®, an EXYNOS™ series processor manufactured by Samsung®, an A series processor manufactured by Apple®, a HELIO™ series processor manufactured by MediaTek®, an ATOM™ series processor manufactured by INTEL®, or a corresponding next-generation processor.

The power management module 1091 manages power for the processor 1020 and/or the transceiver 1031. The battery 1092 supplies power to the power management module 1091. The display 1041 outputs a result processed by the processor 1020. The input unit 1053 receives an input to be used by the processor 1020. The input unit 1053 may be displayed on the display 1041. The SIM card is an integrated circuit used to safely store an international mobile subscriber identity (IMSI) used to identify and authenticate a subscriber and a key related thereto in a portable phone and a portable phone device such as a computer. Contacts information may be stored in many SIM cards.

The memory 1010 is operatively coupled to the processor 1020, and stores a variety of information for operating the processor 1020. The memory 1010 may include a read-only memory (ROM), a random access memory (RAM), a flash memory, a memory card, a storage medium, and/or other equivalent storage devices. When the embodiment is implemented in software, the techniques explained in the present specification can be implemented with a module (i.e., procedure, function, etc.) for performing the functions explained in the present specification. The module may be stored in the memory 1010 and may be performed by the processor 1020. The memory 1010 may be implemented inside the processor 1020. Alternatively, the memory 1010 may be implemented outside the processor 1020, and may be coupled to the processor 1020 in a communicable manner by using various well-known means.

The transceiver 1031 is operatively coupled to the processor 1020, and transmits and/or receives a radio signal. The transceiver 1031 includes a transmitter and a receiver. The transceiver 1031 may include a baseband signal for processing a radio frequency signal. The transceiver controls one or more antennas to transmit and/or receive a radio signal. In order to initiate communication, the processor 1020 transfers command information to the transceiver 1031, for example, to transmit a radio signal constituting voice communication data. The antenna serves to transmit and receive a radio signal. When the radio signal is received, the transceiver 1031 may transfer a signal to be processed by the processor 1020, and may convert the signal into a baseband signal. The processed signal may be converted into audible or readable information which is output through the speaker 1042.

The speaker 1042 outputs a result related to a sound processed by the processor 1020. The microphone 1052 receives a sound-related input to be used by the processor 1020.

A user presses (or touches) a button of the input unit 1053 or drives voice (activates voice) by using the microphone 1052 to input command information such as a phone number or the like. The processor 1020 receives the command information, and performs a proper function such as calling the phone number or the like. Operational data may be extracted from the SIM card or the memory 1010. In addition, the processor 1020 may display command information or operational information on the display 1041 for user's recognition and convenience.

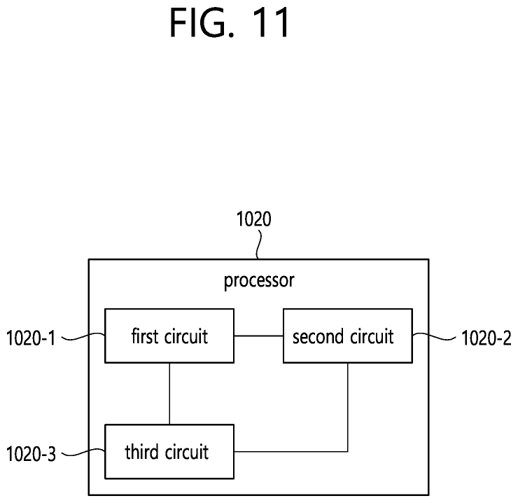

FIG. 11 Shows a Block Diagram of a Processor in which the Disclosure of the Present Specification is Implemented.

As can be seen with reference to FIG. 11, a processor 1020, in which the disclosure of this specification is implemented, may include a plurality of circuitry to implement the proposed functions, procedures and/or methods described herein. For example, the processor 1020 may include a first circuit 1020-1, a second circuit 1020-2, and a third circuit 1020-3. Also, although not shown, the processor 1020 may include more circuits. Each circuit may include a plurality of transistors.

The processor 1020 may be referred to as an application-specific integrated circuit (ASIC) or an application processor (AP), and may include at least one of a digital signal processor (DSP), a central processing unit (CPU), and a graphics processing unit (GPU).

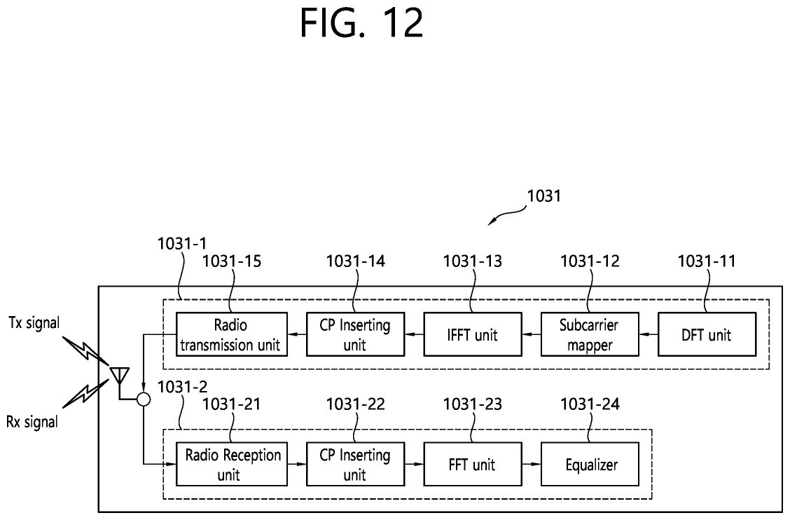

FIG. 12 is a Detailed Block Diagram Illustrating a Transceiver of the First Device Shown in FIG. 9 or a Transceiver of the Device Shown in FIG. 10.

Referring to FIG. 12, a transceiver 1031 includes a transmitter 1031-1 and a receiver 1031-2. The transmitter 1031-1 includes a Discrete Fourier Transform (DFT) unit 1031-11, a subcarrier mapper 1031-12, an IFFT unit 1031-13, a CP insertion unit 1031-14, a wireless transmitter 1031-15. In addition, the transceiver 1031 may further include a scramble unit (not shown), a modulation mapper (not shown), a layer mapper (not shown), and a layer permutator, and the transceiver 1031 may be disposed in front of the DFT unit 1031-11. That is, in order to prevent a peak-to-average power ratio (PAPR) from increasing, the transmitter 1031-1 may transmit information to pass through the DFT unit 1031-11 before mapping a signal to a subcarrier. A signal spread (or pre-coded for the same meaning) by the DFT unit 1031-11 is subcarrier-mapped by the subcarrier mapper 1031-12, and then generated as a time domain signal by passing through the IFFT unit 1031-13.

The DFT unit 1031-11 performs DFT on input symbols to output complex-valued symbols. For example, if Ntx symbols are input (here, Ntx is a natural number), a DFT size may be Ntx. The DFT unit 1031-11 may be called a transform precoder. The subcarrier mapper 1031-12 maps the complex-valued symbols to subcarriers of a frequency domain. The complex-valued symbols may be mapped to resource elements corresponding to a resource block allocated for data transmission. The subcarrier mapper 1031-12 may be called a resource element mapper. The IFFT unit 1031-13 may perform IFFT on input symbols to output a baseband signal for data, which is a time-domain signal. The CP inserter 1031-14 copies a rear portion of the baseband signal for data and inserts the copied portion into a front part of the baseband signal. The CP insertion prevents Inter-Symbol Interference (ISI) and Inter-Carrier Interference (ICI), and therefore, orthogonality may be maintained even in multi-path channels.

Meanwhile, the receiver 1031-2 includes a wireless receiver 1031-21, a CP remover 1031-22, an FFT unit 1031-23, and an equalizer 1031-24, and so on. The wireless receiver 1031-21, the CP remover 1031-22, and the FFT unit 1031-23 of the receiver 1031-2 performs functions inverse to functions of the wireless transmitter 1031-15, the CP inserter 1031-14, and the IFFT unit 1031-13 of the transmitter 1031-1. The receiver 1031-2 may further include a demodulator.

V. Examples to which the Disclosure of the Present Specification can be Applied

Although not limited thereto, the various descriptions, functions, procedures, suggestions, methods, and/or flow charts of the disclosure of the present specification disclosed herein may be applied to various fields requiring wireless communication/connection (eg, 5G) between devices.

Hereinafter, it will be exemplified in more detail with reference to the drawings. In the following drawings/descriptions, the same reference numerals may represent the same or corresponding hardware blocks, software blocks, or functional blocks, unless otherwise indicated.

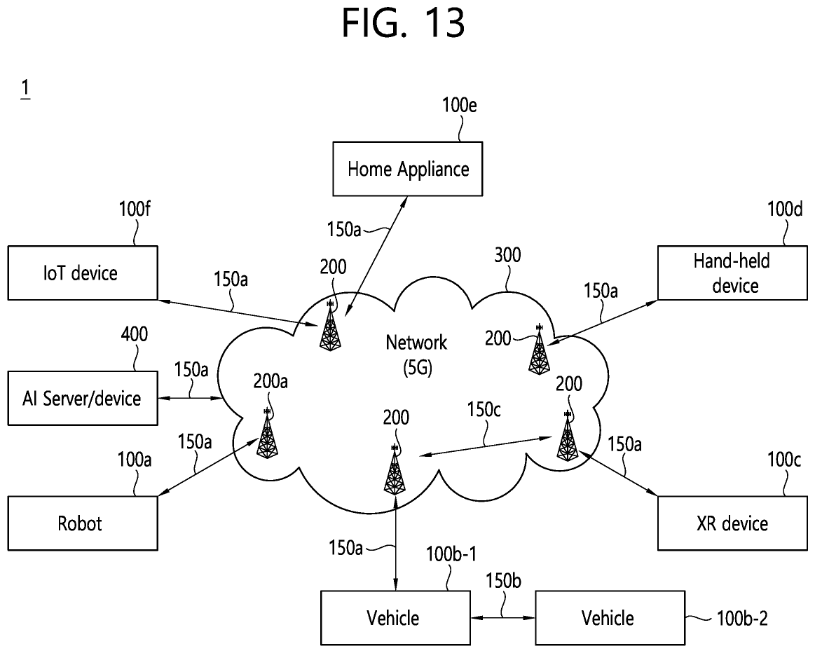

FIG. 13 Illustrates a Communication System 1 that can be Applied to the Present Specification.

Referring to FIG. 13, a communication system 1 applied to the present specification includes a wireless device, a base station, and a network. Here, the wireless device means a device that performs communication using a wireless access technology (e.g., 5G New RAT (Long Term), Long Term Evolution (LTE)), and may be referred to as a communication/wireless/5G device. Although not limited thereto, the wireless device may include a robot 100a, a vehicle 100b-1, 100b-2, an eXtended Reality (XR) device 100c, a hand-held device 100d, a home appliance 100e, an Internet of Thing (IoT) device 100f, and the AI device/server 400. For example, the vehicle may include a vehicle having a wireless communication function, an autonomous vehicle, a vehicle capable of performing inter-vehicle communication, and the like. Here, the vehicle may include an unmanned aerial vehicle (UAV) (e.g., a drone). XR device may include AR (Augmented Reality)/VR (Virtual Reality)/MR (Mixed Reality) device. XR device may be implemented in the form of Head-Mounted Device (HMD), Head-Up Display (HUD), television, smartphone, a computer, a wearable device, a home appliance, a digital signage, a vehicle, a robot, and the like. The mobile device may include a smartphone, a smart pad, a wearable device (e.g., smart watch, smart glasses), and a computer (e.g., a laptop, etc.). The home appliance may include a TV, a refrigerator, a washing machine, and the like. IoT devices may include sensors, smart meters, and the like. For example, the base station and the network may be implemented as a wireless device, and the specific wireless device 200a may operate as a base station/network node to other wireless devices.

The wireless devices 100a to 100f may be connected to the network 300 through the base station 200. AI (Artificial Intelligence) technology may be applied to the wireless devices 100a to 100f, and the wireless devices 100a to 100f may be connected to the AI server 400 through the network 300. The network 300 may be configured using a 3G network, a 4G (e.g. LTE) network, a 5G (e.g. NR) network, or the like. The wireless devices 100a-100f may communicate with each other via the base station 200/network 300, but may also communicate directly (e.g. sidelink communication) without passing through the base station/network. For example, the vehicles 100b-1 and 100b-2 may perform direct communication (e.g. vehicle to vehicle (V2V)/vehicle to everything (V2X) communication). In addition, the IoT device (e.g. sensor) may directly communicate with another IoT device (e.g. sensor) or another wireless device 100a to 100f.

A wireless communication/connection 150a, 150b, 150c may be performed between the wireless devices 100a-100f/base station 200 and base station 200/base station 200. Here, the wireless communication/connection is implemented based on various wireless connections (e.g., 5G NR) such as uplink/downlink communication 150a, sidelink communication 150b (or D2D communication), inter-base station communication 150c (e.g. relay, integrated access backhaul), and the like. The wireless device and the base station/wireless device, the base station, and the base station may transmit/receive radio signals to each other through the wireless communication/connections 150a, 150b, and 150c. For example, wireless communications/connections 150a, 150b, 150c may transmit/receive signals over various physical channels. To this end, based on various proposals of the present specification, At least some of various configuration information setting processes for transmitting/receiving a wireless signal, various signal processing processes (e.g., channel encoding/decoding, modulation/demodulation, resource mapping/demapping, etc.) may be performed.

As described above, although the embodiments have been described as examples, since the content and scope of this specification will not be limited only to a particular embodiment of this specification, this specification may be amended, modified, or enhanced to other various forms.

In the above exemplary systems, although the methods have been described on the basis of the flowcharts using a series of the steps or blocks, the present disclosure is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present disclosure.

Claims in the present description can be combined in a various way. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method.

What is claimed is:

1. A V2X (vehicle to everything) communication method on a sidelink, performed by a V2X device, the method comprising:
selecting one from among a plurality of synchronization reference sources that can be used for transmission of the V2X signal on the sidelink,
wherein the plurality of synchronization reference sources include a global navigation satellite system (GNSS), a new radio (NR) based cell, a long term evolution (LTE) based cell, and a synchronization reference user equipment (SyncRefUE);
based on that the NR-based cell or the LTE-based cell is selected as the synchronization reference source, performing time synchronization for transmission of the V2X signal on the sidelink, based on the downlink signal from the NR-based cell or LTE-based cell; and
transmitting a V2X signal on the sidelink, based on the synchronization,
wherein a transmission timing error (Tₑ) is defined for the transmission of the V2X signal on the sidelink,
wherein the transmission timing error (Tₑ) is predetermined based on the subcarrier spacing (SCS) of the V2X signal on the sidelink, and the subcarrier spacing (SCS) includes 15 kHz, 30 kHz, 60 kHz, and 120 kHz.

2. The method of claim 1,
wherein the V2X communication performed on the sidelink is NR-based or LTE-based.

3. The method of claim 1,
based on that the NR-based cell is selected as the synchronization reference source, and based on that the V2X communication performed on the sidelink is NR-based,
wherein the transmission timing error (Tₑ) is defined as a timing error (NR_V2X_Tₑ) for V2X communication on the NR-based sidelink in the table below,

| Frequency | SCS of SSB signal | SCS of sidelink | |
|---|---|---|---|
| Range | (KHz) | signal (KHz) | NR_V2X_Tₑ |
| FR1 | 15 | 15 | 12 * 64 * Tc |
| | | 30 | 10 * 64 * Tc |
| | | 60(FR1) | 10 * 64 * Tc |
| | | 60(FR2) | [10 ± Δ] * 64 * Tc |
| | | 120 | [10 ± Δ] ** 64 * Tc |
| | 30 | 15 | 8 * 64 * Tc |
| | | 30 | 8 * 64 * Tc |
| | | 60(FR1) | 7 * 64 * Tc |
| | | 60(FR2) | [7 ± Δ] * 64 * Tc |
| | | 120 | [7 ± Δ] * 64 * Tc |

Here, Δ = 2 is proposed for the range error of the standard value.
wherein the Tc is basic time unit.

4. The method of claim 1,
based on that the NR-based cell is selected as the synchronization reference source, and based on that the V2X communication performed on the sidelink is NR-based,
wherein the transmission timing error (Tₑ) is defined as a timing error (NR_V2X_Tₑ) for V2X communication on the NR-based sidelink in the table below,

| | SCS of SSB | SCS of | |
|---|---|---|---|
| Frequency | signal | sidelink | |
| Range | (KHz) | signal (KHz) | NR_V2X_Tₑ |
| FR2 | 120 | 15 | [4.5 ± Δ] * 64 * Tc |
| | | 30 | [4.5 ± Δ] * 64 * Tc |
| | | 60(FR1) | [4.5 ± Δ] * 64 * Tc |
| | | 60(FR2) | [3.5 ± Δ] * 64 * Tc |
| | | 120 | [3.5 ± Δ] * 64 * Tc |
| | 240 | 15 | [4 ± Δ] * 64 * Tc |
| | | 30 | [4 ± Δ] * 64 * Tc |
| | | 60(FR1) | [4 ± Δ] * 64 * Tc |
| | | 60(FR2) | [3 ± Δ] * 64 * Tc |
| | | 120 | [3 ± Δ] * 64 * Tc |

Here, Δ = 2 is proposed for the range error of the standard value.
wherein the Tc is basic time unit.

5. The method of claim 1,
based on that the LTE-based cell is selected as the synchronization reference source, and based on that the V2X communication performed on the sidelink is NR-based,
wherein the transmission timing error (Tₑ) is defined as a timing error (NR_V2X_Tₑ) for V2X communication on the NR-based sidelink in the table below,

| | Channel | | |
|---|---|---|---|
| | bandwidth | | |
| Fre- | of LTE | SCS of | |
| quency | based downlink | sidelink | NR_V2X_Te |
| Range | (CBW) [MHz] | signal (KHz) | (Ts(Tc)) |
| FR1 | 3 | 15, 30, 60, 120 | 12Ts(12 * 64 * Tc) |
| | 5 | 15, 30, 60, 120 | 12Ts(12 * 64 * Tc) or |
| | | | 10Ts(10 * 64 * Tc) |
| | 10 | 15, 30, 60, 120 | 8Ts(8 * 64 * Tc) |
| | 15 | 15, 30, 60, 120 | 7Ts(7 * 64 * Tc) |
| | 20 | 15, 30, 60, 120 | 5Ts(5 * 64 * Tc) |
| FR1 | 3, 5 | 60, 120 | (10 ± Δ)Ts((10 ± Δ) * 64 * Tc) |
| | 10, 15 | 60, 120 | (6 ± Δ)Ts((6 ± Δ) * 64 * Tc) |
| | 20 | 60, 120 | (4 ± Δ)Ts((4 ± Δ) * 64 * Tc) |

Here, Δ = 2 is proposed for the range error of the standard value.
wherein the Tc is basic time unit.

6. The method of claim 1,
based on that the LTE-based cell is selected as the synchronization reference source, and based on that the V2X communication performed on the sidelink is LTE-based,
wherein the transmission timing error (Tₑ) is defined as a timing error (LTE_V2X_Tₑ) for V2X communication on the LTE-based sidelink in the table below,

| NR | SCS of SSB | SCS of LTE | |
|---|---|---|---|
| Frequency | signal | based V2X | 5G LTE_V2X_Te |
| Range | (KHz) | signal (KHz) | (Ts(Tc)) |
| FR1 | 15 | 15 | (12 ± Δ)Ts((12 ± Δ) * 64 * Tc) |
| | 30 | 15 | (9 ± Δ)Ts((9 ± Δ) * 64 * Tc) |
| FR2 | 120 | 15 | (7 ± Δ)Ts((7 ± Δ) * 64 * Tc) |
| | 240 | 15 | (7 ± Δ)Ts((7 ± Δ) * 64 * Tc) |

Here, Δ = 2 is proposed for the range error of the standard value.
wherein the Tc is basic time unit.

7. A V2X (vehicle to everything) device that performs V2X communication on a sidelink, the V2X device comprising:
at least one processor; and
at least one memory for storing instructions and operably electrically connectable with the at least one processor, wherein the instructions, performed based on executed by the at least one processor, include:
selecting one from among a plurality of synchronization reference sources that can be used for transmission of the V2X signal on the sidelink,
wherein the plurality of synchronization reference sources include a global navigation satellite system (GNSS), a new radio (NR) based cell, a long term evolution (LTE) based cell, and a synchronization reference user equipment (SyncRefUE);
based on that the NR-based cell or the LTE-based cell is selected as the synchronization reference source, performing time synchronization for transmission of the V2X signal on the sidelink, based on the downlink signal from the NR-based cell or LTE-based cell; and
transmitting a V2X signal on the sidelink, based on the synchronization,
wherein a transmission timing error (Tₑ) is defined for the transmission of the V2X signal on the sidelink,
wherein the transmission timing error (Tₑ) is predetermined based on the subcarrier spacing (SCS) of the V2X signal on the sidelink, and the subcarrier spacing (SCS) includes 15 kHz, 30 kHz, 60 kHz, and 120 kHz.

8. The V2X device of claim 7,
wherein the V2X communication performed on the sidelink is NR-based or LTE-based.

9. The V2X device of claim 7,
based on that the NR-based cell is selected as the synchronization reference source, and based on that the V2X communication performed on the sidelink is NR-based,
wherein the transmission timing error (Tₑ) is defined as a timing error (NR_V2X_Tₑ) for V2X communication on the NR-based sidelink in the table below,

| Frequency | SCS of SSB signal | SCS of sidelink | |
|---|---|---|---|
| Range | (KHz) | signal (KHz) | NR_V2X_Tₑ |
| FR1 | 15 | 15 | 12 * 64 * Tc |
| | | 30 | 10 * 64 * Tc |
| | | 60(FR1) | 10 * 64 * Tc |
| | | 60(FR2) | [10 ± Δ]*64 * Tc |
| | | 120 | [10 ± Δ] ** 64 * Tc |
| | 30 | 15 | 8 * 64 * Tc |
| | | 30 | 8 * 64 * Tc |
| | | 60(FR1) | 7 * 64 * Tc |
| | | 60(FR2) | [7 ± Δ] * 64 * Tc |
| | | 120 | [7 ± Δ] * 64 * Tc |

Here, Δ = 2 is proposed for the range error of the standard value.
wherein the Tc is basic time unit.

10. The V2X device of claim 7,
based on that the NR-based cell is selected as the synchronization reference source, and based on that the V2X communication performed on the sidelink is NR-based,
wherein the transmission timing error (Tₑ) is defined as a timing error (NR_V2X_Tₑ) for V2X communication on the NR-based sidelink in the table below,

| | SCS of SSB | SCS of | |
|---|---|---|---|
| Frequency | signal | sidelink | |
| Range | (KHz) | signal (KHz) | NR_V2X_Tₑ |
| FR2 | 120 | 15 | [4.5 ± Δ] * 64 * Tc |
| | | 30 | [4.5 ± Δ] * 64 * Tc |
| | | 60(FR1) | [4.5 ± Δ] * 64 * Tc |
| | | 60(FR2) | [3.5 ± Δ] * 64 * Tc |
| | | 120 | [3.5 ± Δ] * 64 * Tc |
| | 240 | 15 | [4 ± Δ] * 64 * Tc |
| | | 30 | [4 ± Δ] * 64 * Tc |
| | | 60(FR1) | [4 ± Δ] * 64 * Tc |
| | | 60(FR2) | [3 ± Δ] * 64 * Tc |
| | | 120 | [3 ± Δ] * 64 * Tc |

Here, Δ = 2 is proposed for the range error of the standard value.
wherein the Tc is basic time unit.

11. The V2X device of claim 7,
based on that the LTE-based cell is selected as the synchronization reference source, and based on that the V2X communication performed on the sidelink is NR-based,
wherein the transmission timing error (Tₑ) is defined as a timing error (NR_V2X_Tₑ) for V2X communication on the NR-based sidelink in the table below,

| | Channel | | |
|---|---|---|---|
| | bandwidth | | |
| Fre- | of LTE | SCS of | |
| quency | based downlink | sidelink | NR_V2X_Te |
| Range | (CBW) [MHz] | signal (KHz) | (Ts(Tc)) |
| FR1 | 3 | 15, 30, 60, 120 | 12Ts(12 * 64 * Tc) |
| | 5 | 15, 30, 60, 120 | 12Ts(12 * 64 * Tc) or |
| | | | 10Ts(10 * 64 * Tc) |
| | 10 | 15, 30, 60, 120 | 8Ts(8 * 64 * Tc) |
| | 15 | 15, 30, 60, 120 | 7Ts(7 * 64 * Tc) |
| | 20 | 15, 30, 60, 120 | 5Ts(5 * 64 * Tc) |
| FR1 | 3, 5 | 60, 120 | (10 ± Δ)Ts((10 ± Δ) * 64 * Tc) |
| | 10, 15 | 60, 120 | (6 ± Δ)Ts((6 ± Δ) * 64 * Tc) |
| | 20 | 60, 120 | (4 ± Δ)Ts((4 ± Δ) * 64 * Tc) |

Here, Δ = 2 is proposed for the range error of the standard value.
wherein the Tc is basic time unit.

12. The V2X device of claim 7,
based on that the LTE-based cell is selected as the synchronization reference source, and based on that the V2X communication performed on the sidelink is LTE-based,
wherein the transmission timing error (Tₑ) is defined as a timing error (LTE_V2X_Tₑ) for V2X communication on the LTE-based sidelink in the table below,

| NR | SCS of SSB | SCS of LTE | |
|---|---|---|---|
| Frequency | signal | based V2X | 5G LTE_V2X_Te |
| Range | (KHz) | signal (KHz) | (Ts(Tc)) |
| FR1 | 15 | 15 | (12 ± Δ)Ts((12 ± Δ) * 64 * Tc) |
| | 30 | 15 | (9 ± Δ)Ts((9 ± Δ) * 64 * Tc) |
| FR2 | 120 | 15 | (7 ± Δ)Ts((7 ± Δ) * 64 * Tc) |
| | 240 | 15 | (7 ± Δ)Ts((7 ± Δ) * 64 * Tc) |

Here, Δ = 2 is proposed for the range error of the standard value.
wherein the Tc is basic time unit.

13. A non-volatile computer readable storage medium storing instructions,
wherein the instructions, when executed by one or more processors, cause the one or more processors to perform operations including:
selecting one from among a plurality of synchronization reference sources that can be used for transmission of the V2X signal on the sidelink,
wherein the plurality of synchronization reference sources include a global navigation satellite system (GNSS), a new radio (NR) based cell, a long term evolution (LTE) based cell, and a synchronization reference user equipment (SyncRefUE);
based on that the NR-based cell or the LTE-based cell is selected as the synchronization reference source, performing time synchronization for transmission of the V2X signal on the sidelink, based on the downlink signal from the NR-based cell or LTE-based cell; and
transmitting a V2X signal on the sidelink, based on the synchronization,
wherein a transmission timing error (Tₑ) is defined for the transmission of the V2X signal on the sidelink,
wherein the transmission timing error (Tₑ) is predetermined based on the subcarrier spacing (SCS) of the V2X signal on the sidelink, and the subcarrier spacing (SCS) includes 15 kHz, 30 kHz, 60 kHz, and 120 kHz.
